(19) United States
(12) Patent Application Publication
(10) Pub. No.: US 2022/0136575 A1
(43) Pub. Date: May 5, 2022

(54) WHEEL AND BRAKE ASSEMBLIES

(71) Applicant: Somnio Global Holdings, LLC, Novi, MI (US)

(72) Inventors: Pravansu S. Mohanty, Novi, MI (US); Vikram Varadaraajan, Novi, MI (US)

(73) Assignee: Somnio Global Holdings, LLC, Novi, MI (US)

(21) Appl. No.: 17/434,269

(22) PCT Filed: Feb. 26, 2020
(86) PCT No.: PCT/US2020/019934

§ 371 Date: Aug. 26, 2021

Related U.S. Application Data
(60) Provisional application No. 62/810,686, filed on Feb. 26, 2019.

(51) Int. Cl. F16D 55/32; B60K 7/00; B60L 7/24; F16D 61/00; F16D 65/00

(52) U.S. Cl. CPC F16D 55/32; B60K 7/0007; F16D 2121/20; F16D 61/00; F16D 65/0056; B60L 7/24

(57) ABSTRACT

A braking assembly for inhibiting rotation of a wheel around a rotation axis is provided. The braking assembly includes a drive gear, an actuator, an electric braking assembly, a mechanical braking assembly including a brake pad, and a brake rotor fixedly coupled to the wheel. The drive gear rotates with the wheel and includes a pinion. The electric braking assembly includes a coil surrounding the rotation axis, and a magnetic disc assembly concentric with the coil and configured to rotate relative to the coil. The magnetic disc assembly includes a plurality of magnets at a perimeter of the disc. The actuator engages the pinion to inhibit rotation of the magnets and generate an electro motive force to inhibit rotation of the wheel. The actuator engages the brake pad to contact the rotor and inhibit rotation between the wheel and the brake pad.

### CROSS-REFERENCE TO RELATED APPLICATION

This application is a non-provisional application which claims priority to co-pending U.S. Provisional Patent Application No. 62/810,686, filed Feb. 26, 2019, for “Wheel and Brake Assemblies,” which is hereby incorporated by reference in its entirety including the drawings.

### TECHNICAL FIELD

The present disclosure generally relates to wheels, systems, and methods for braking and, more particularly, to automotive alloy wheels with an integral braking surface and methods for providing deceleration, reducing weight, and enhancing energy efficiency.

### BACKGROUND

Wheels made from aluminum, magnesium, or titanium alloys are becoming standard features for many automobiles. Generally termed as “alloy wheels,” they are significantly lighter than steel ones, and benefit vehicles in terms of fuel economy, braking, and accelerating. Steering and handling is also often improved with lighter wheels. The alloy wheels also help limit wear and tear on other vehicle components such as the engine, transmission, suspension, and the like. Alloy wheels also permit better heat conduction and dissipation, which directly translates to better braking. Enhanced heat dissipation also keeps tires cooler and reduces wear. Further, alloy wheels are more resistant to corrosion and rust, and aesthetically look far more stylish compared to steel wheels.

While aluminum, magnesium, or titanium alloy wheels provide many benefits, for braking, heavier steel or cast iron disc or drum rotors are generally used, which are separately manufactured and fastened to a hub. Besides significant weight addition to the vehicle, galvanic incompatibility between iron and aluminum/magnesium/titanium alloys often necessitates isolation between the wheel and the brake rotor. Further, the steel/cast iron rotors are prone to corrosion and rust, which affect the braking performance and dust generation, as well as impact the aesthetics of the vehicle. Furthermore, hybrid and electric vehicles are prone to enhanced corrosion and rust due to reduced use of mechanical brakes.

If the same light alloys that are used to make the wheels can be utilized to make the brake rotor, then the vehicle weight can be further reduced, leading to higher energy efficiency as well as better braking performance. Furthermore, the brake rotor/braking surface can then be integrated into the alloy wheel as a single component to improve heat dissipation and simplify manufacturing and assembly.

Accordingly, a need exists for improved automotive alloy wheels that provide deceleration, reduce weight, and enhance energy efficiency.

### SUMMARY

In one embodiment, a braking assembly for inhibiting rotation of a wheel around a rotation axis includes a drive gear, an actuator, an electric braking assembly, a mechanical braking assembly, and a brake rotor. The drive gear is configured to rotate with the wheel and includes a pinion. The electric braking assembly includes a coil surrounding the rotation axis, and a magnetic disc assembly concentric with the coil and configured to rotate relative to the coil. The magnetic disc assembly includes a plurality of magnets at a perimeter of the disc. The mechanical braking assembly includes a brake pad. The brake rotor is fixedly coupled to the wheel. The actuator engages the pinion to mechanically couple the drive gear and the magnetic disc assembly to cause relative rotation between the plurality of magnets and the coil to generate an electro motive force that inhibits rotation of the wheel around the rotation axis. The actuator also engages the brake pad such that the brake pad contacts the brake rotor causing friction that inhibits relative rotation between the wheel and the brake pad.

In another embodiment, a wheel assembly includes a wheel and an integrated brake rotor. The wheel includes a hub, a rim, and one or more spokes extending between the hub and the rim. The integrated brake rotor includes a braking surface, a plurality of fins, and an alloy.

In yet another embodiment, a wheel and brake assembly for inhibiting rotation of a wheel around a rotation axis includes a wheel, a mechanical braking assembly, and a brake rotor fixedly coupled to the wheel. The wheel includes a hub, a rim, and one or more spokes extending between the hub and the rim. The mechanical braking assembly includes an actuator and a brake pad. The actuator engages the brake pad such that the brake pad contacts the brake rotor causing friction that inhibits relative rotation between the wheel and the brake pad. The brake rotor and the wheel are each formed from one or more alloys.

In yet another embodiment, a motor/generator assembly for rotating and inhibiting rotation of a wheel on a vehicle includes a rotating bearing, a rotor coil mounted to an axle such that it rotates with the axle as the wheel rotates, a stator including one or more magnets, the stator coupled to the rotor coil via the rotating bearing and concentric with the rotor coil about the axle, and an actuation assembly including an actuation arm, the actuation assembly configured to actuate the actuation arm to contact the stator. Contact of the actuation arm with the stator inhibits rotation of the stator with respect to the vehicle, thereby causing relative rotation between the rotor coil and the stator.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1A schematically depicts a perspective view of an illustrative wheel, a cast iron disc brake rotor, and a caliper braking device according to one or more embodiments known in the prior art;

FIG. 1B schematically depicts a perspective view of the wheel, the cast iron disc brake rotor, and the caliper braking device of FIG. 1A assembled onto a vehicle knuckle according to one or more embodiments known in the prior art;

FIG. 2A schematically depicts a perspective view of an illustrative wheel, a cast iron drum brake rotor, and a drum braking device having a plurality of brake shoes and pistons according to one or more embodiments known in the prior art;

FIG. 2B schematically depicts a perspective cutaway view of the wheel, the cast iron drum brake rotor, and the drum braking device of FIG. 2A assembled onto a vehicle knuckle according to one or more embodiments known in the prior art;

FIG. 3A schematically depicts a perspective view of an illustrative wheel assembly including a wheel having an integrated brake rotor according to one or more embodiments shown and described herein;

FIG. 3B schematically depicts a perspective cutaway view of the wheel assembly of FIG. 3A according to one or more embodiments shown and described herein;

FIG. 4A schematically depicts a planar view of the wheel assembly of FIG. 3A according to one or more embodiments shown and described herein;

FIG. 4B schematically depicts a perspective cutaway view of the wheel assembly of FIG. 3A according to one or more embodiments shown and described herein;

FIG. 5A schematically depicts a perspective cutaway view of the wheel assembly of FIG. 3A including a liner according to one or more embodiments shown and described herein;

FIG. 5B schematically depicts a planar view of the wheel assembly of FIG. 3A including the liner according to one or more embodiments shown and described herein;

FIG. 6A schematically depicts a perspective cutaway view of an illustrative wheel and brake assembly including the wheel assembly of FIG. 3A and a mechanical braking assembly according to one or more embodiments shown and described herein;

FIG. 6B schematically depicts a perspective front view of the mechanical braking assembly of FIG. 6A according to one or more embodiments shown and described herein;

FIG. 6C schematically depicts a perspective back view of the mechanical braking assembly of FIG. 6A according to one or more embodiments shown and described herein;

FIG. 7A schematically depicts a perspective exploded cutaway view of the wheel and brake assembly of FIG. 6A including a wheel bearing and a vehicle knuckle according to one or more embodiments shown and described herein;

FIG. 7B schematically depicts a perspective assembled view of the wheel and brake assembly, the wheel bearing, and the vehicle knuckle of FIG. 7A according to one or more embodiments shown and described herein;

FIG. 8A schematically depicts a perspective cutaway view of the wheel and brake assembly of FIG. 6A including a tongue-and-groove assembly according to one or more embodiments shown and described herein;

FIG. 8B schematically depicts a perspective cutaway view of the wheel and brake assembly of FIG. 8A according to one or more embodiments shown and described herein;

FIG. 8C schematically depicts a planar cutaway view of the wheel and brake assembly of FIG. 8A according to one or more embodiments shown and described herein;

FIG. 9A schematically depicts an exploded cutaway view of the wheel and brake assembly of FIG. 6A including a second caliper type brake pad according to one or more embodiments shown and described herein;

FIG. 9B schematically depicts a cutaway view of the wheel and brake assembly of FIG. 9A according to one or more embodiments shown and described herein;

FIG. 10A schematically depicts a perspective rear exploded view of an illustrative wheel and brake assembly including a wheel, a non-integrated brake rotor, a wheel bearing, a mechanical braking assembly, a vehicle knuckle, and a plurality of lug nut-bolt pairs according to one or more embodiments shown and described herein;

FIG. 10B schematically depicts a perspective front exploded view of the wheel and brake assembly of FIG. 10A according to one or more embodiments shown and described herein;

FIG. 11A schematically depicts a perspective view of an illustrative wheel having a drum type integrated brake rotor with a liner according to one or more embodiments shown and described herein;

FIG. 11B schematically depicts a perspective cutaway view of the wheel assembly of FIG. 11A according to one or more embodiments shown and described herein;

FIG. 12A schematically depicts a perspective view of an illustrative mechanical braking assembly for providing a braking force on the drum type integrated brake rotor of FIG. 11A according to one or more embodiments shown and described herein;

FIG. 12B schematically depicts a perspective cutaway view of an illustrative wheel and brake assembly including the wheel assembly of FIG. 11A and the mechanical braking assembly of FIG. 12A according to one or more embodiments shown and described herein;

FIG. 13A schematically depicts a perspective view of an illustrative wheel assembly including an integrated brake rotor with a convex braking surface and a liner according to one or more embodiments shown and described herein;

FIG. 13B schematically depicts a perspective cutaway view of the wheel assembly of FIG. 13A according to one or more embodiments shown and described herein;

FIG. 14A schematically depicts a perspective view of an illustrative mechanical braking assembly according to one or more embodiments shown and described herein;

FIG. 14B schematically depicts a perspective cutaway view of an illustrative wheel and brake assembly including the wheel assembly of FIG. 13A and the mechanical braking assembly of FIG. 14A according to one or more embodiments shown and described herein;

FIG. 14C schematically depicts a planar cutaway view of the wheel and brake assembly of FIG. 14B according to one or more embodiments shown and described herein;

FIG. 15A schematically depicts a perspective cutaway view of an illustrative wheel and brake assembly including a wheel assembly, a mechanical braking assembly, and an electric braking assembly according to one or more embodiments shown and described herein;

FIG. 15B schematically depicts a planar view of the wheel and brake assembly of FIG. 15A according to one or more embodiments shown and described herein;

FIG. 16A schematically depicts a perspective exploded cutaway view of the wheel and brake assembly of FIG. 15A according to one or more embodiments shown and described herein;

FIG. 16B schematically depicts a planar cutaway view of the wheel and brake assembly of FIG. 15A according to one or more embodiments shown and described herein;

FIG. 17A schematically depicts a perspective view of an illustrative motor/generator assembly including a wheel assembly and a motor/generator according to one or more embodiments shown and described herein;

FIG. 17B schematically depicts a perspective cutaway view the motor/generator assembly of FIG. 17A according to one or more embodiments shown and described herein;

FIG. 18A schematically depicts a perspective view of the motor/generator assembly of FIG. 17A including an engagement arm in a first position according to one or more embodiments shown and described herein;

FIG. 18B schematically depicts a perspective cutaway view of the motor/generator assembly of FIG. 18A according to one or more embodiments shown and described herein; and

FIG. 18C schematically depicts a perspective view of the motor/generator assembly of FIG. 18A with the engagement arm in a second position according to one or more embodiments shown and described herein.

### DETAILED DESCRIPTION

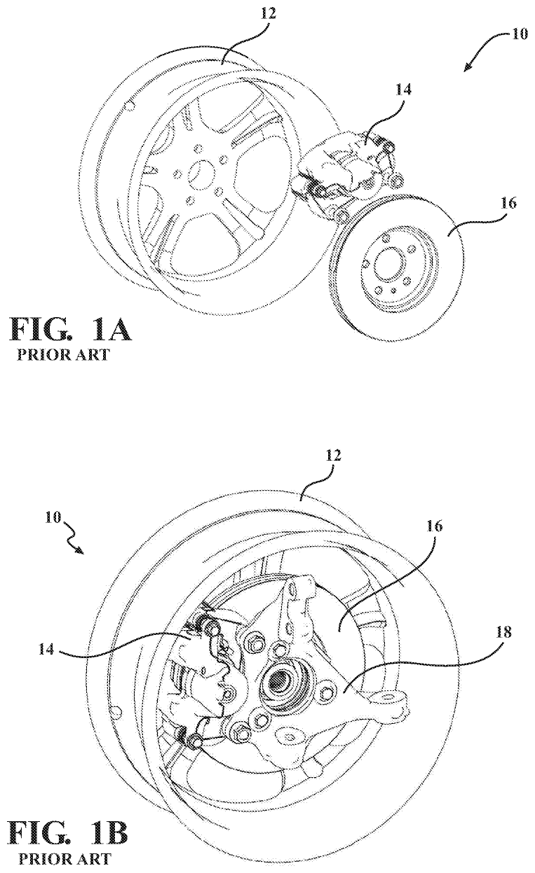

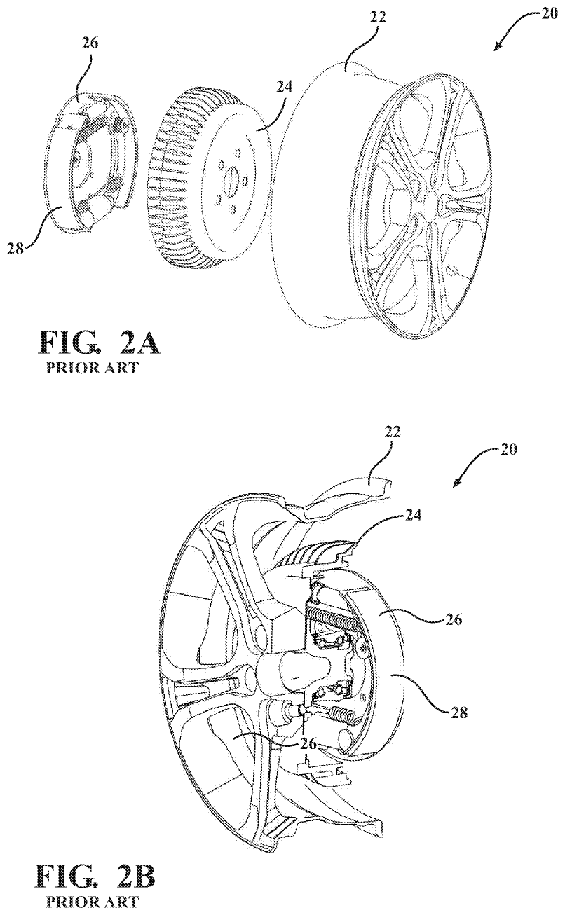

FIGS. 1A, 1B, 2A, and 2B show prior art wheel and brake assemblies. FIGS. 1A and 1B show a wheel and brake assembly 10 that includes a wheel 12, a caliper assembly 14, a disc type steel brake rotor 16, and a knuckle 18. The wheel 12 and the steel brake rotor 16 are separate components and the caliper assembly 14 may actuate the brake pads (not shown) to create friction with the steel brake rotor 16 and inhibit rotation of the wheel 12. FIGS. 2A and 2B show a wheel and brake assembly 20 including a wheel 22, a drum type steel brake rotor 24, and a brake shoe assembly 26. The brake shoe assembly 26 may include a pair of brake shoes 28 lined with brake pads that expand radially to contact the steel brake rotor 24 and inhibit rotation of the wheel 22.

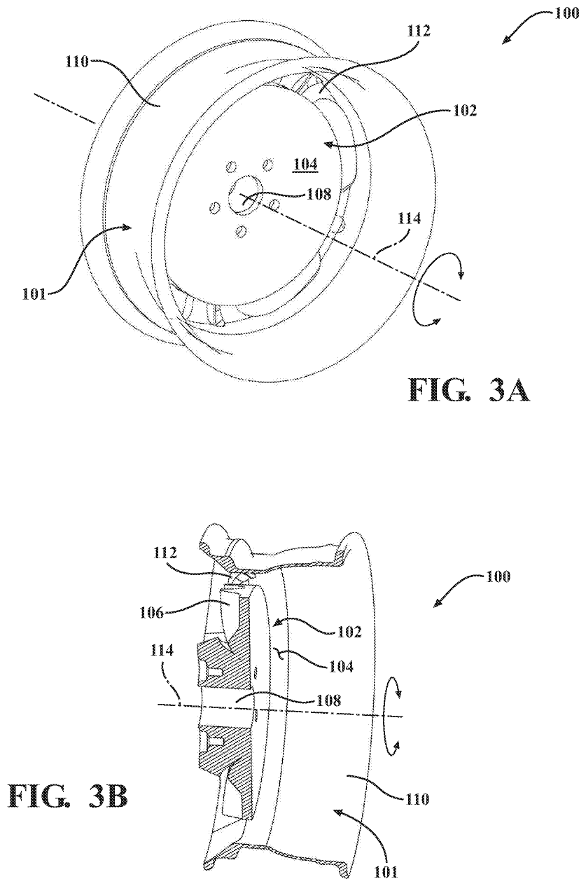

Referring now to FIG. 3A and 3B, a wheel assembly 100 that includes a wheel 101 and a brake rotor 102 including a braking surface 104 and a plurality of fins 106 is shown. The wheel assembly 100 also includes a hub 108, a rim 110, one or more spokes 112 extending between the hub 108 and the rim 110. The wheel assembly 100 may be configured to rotate around a rotation axis 114 and may, in some embodiments, be configured to couple to one or more vehicle components for installation on a vehicle as described in greater detail herein.

In embodiments described herein, the brake rotor 102 is an integrated brake rotor. As used herein, the term “integrated” or “integral” refers to two components being integrally formed as a one piece, monolithic structure formed of the same material. The integrated brake rotor 102 may be monolithic with one or more of the hub 108, the rim 110, and the one or more spokes 112. In some embodiments, the brake rotor 102 is an alloy such as, for example, an alloy of one or more metals such as aluminum, copper, tin, magnesium, and other materials. In some embodiments, the brake rotor 102 is a reinforced composite, such as, for example, an alloy matrix of one or more metals such as aluminum, copper, tin, magnesium with fiber or particle reinforcement such as C, SiC, or Al₂O₃. In some embodiments, the alloy is a composite material. In some embodiments, the alloy is a SiC (silicon carbide) reinforced aluminum alloy composite. The brake rotor 102 and the other wheel assembly components may be produced using one or more methods, for example, forging, casting (e.g., high pressure die casting, low pressure die or sand casting, gravity casting, and the like), extrusion, MIG welding, and powder coating. In some embodiments, the brake rotor is machined into shape from a 6061 aluminum block and the wheel 101 is cast from an A356 aluminum alloy by sand casting. The wheel assembly 100 is then formed by MIG welding of the brake rotor 102 and the wheel 101. As shown in FIG. 3B, the integrated brake rotor 102 may extend radially outward from the hub 108 and be connected to the hub 108 along an inner circumference of the brake rotor 102. However, it is to be understood that this is merely an illustrative embodiment and the integrated brake rotor 102 may extend from the wheel 101 at some other location that is integral with the wheel 101. The hub 108 has a through bore defining the same rotation axis 114 as the wheel 101. Additionally, it is within the scope of the present application that, in some embodiments, the brake rotor 102 and the wheel 101 may be separate, non-integral components of a braking assembly, as described in greater detail herein. In some embodiments, the brake rotor 102 and the wheel 101 may be secured to one another through one or more fasteners.

The fins 106 may extend away from the braking surface 104 to remove heat from the braking surface 104 as the brake is actuated and friction is created. In addition, the fins 106 also provide mechanical support to the braking surface 104 (e.g., increase the stiffness). In some embodiments, as described herein, the brake rotor 102 may include multiple braking surfaces and the fins 106 may be situated between the multiple braking surfaces. In the particular illustrated embodiment in FIG. 3B, the fins 106 extend opposite the braking surface 104 such that they remove heat from the braking surface 104 as a brake pad or other braking device contacts the braking surface 104 to inhibit rotation of the wheel 101. The braking surface 104 is thus used as a device for creating friction to inhibit rotation of the wheel 101. As the wheel 101 rotates, heat may transfer to the fins 106 and be convected to air flowing over the fins 106. In some embodiments, the fins 106 may include a tapered profile that tapers (i.e., decreases in cross-sectional area) away from the braking surface 104, such that heat preferentially flows toward a tip of the fins 106. In some embodiments, the cross-sectional area profile of each of the fins 106 is equivalent or the same with respect to a distance along any given fin 106 from the hub 108, but it is contemplated that the cross-sectional area profile of the fins 106 may vary from fin to fin. The fins 106 may be separated from the spokes 112 by a gap such that air can flow between the fins 106 and the spokes 112. Additionally, as mentioned above, the fins 106 may increase the stiffness of the brake rotor 102. For example, the fins 106 may be constructed or oriented at an angle of inclination with respect to a line extending radially from the rotation axis 114. The angle of inclination may increase the degree of resistance to deformation (e.g., flexing, bending, and the like) of the brake rotor 102 with relation to the angle of inclination.

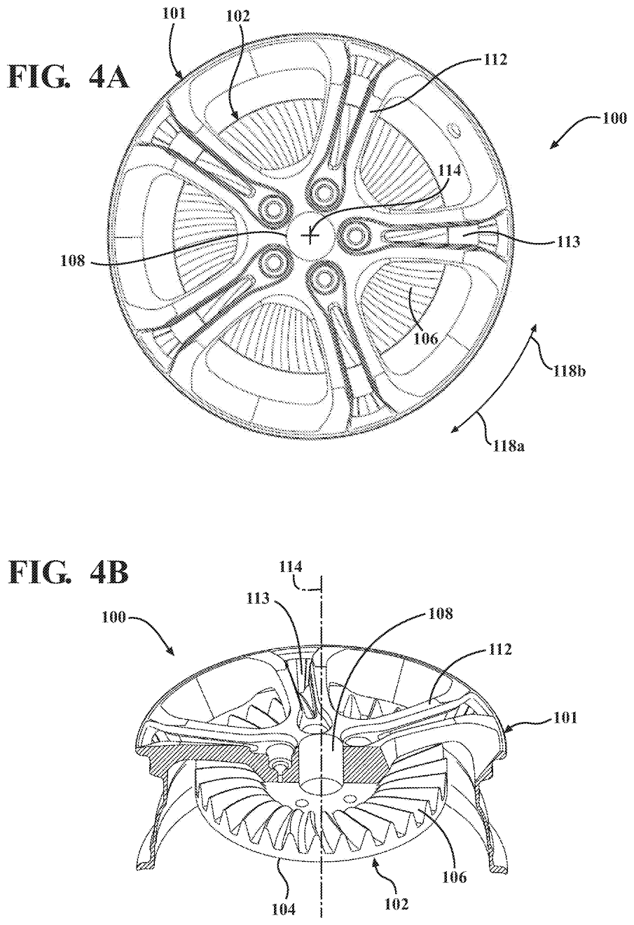

FIGS. 4A and 4B depict the fins 106 and the braking surface 104 as viewed from a front or an outside of the wheel assembly 100 and opposite that illustrated in FIG. 3A. That is, if the wheel assembly 100 were positioned on an axle of a vehicle (not shown), portions of the wheel assembly 100 shown in FIGS. 4A and 4B may be visible to an ordinary observer. As best shown in FIG. 4A, the fins 106 include a forward-sweeping profile. That is, as the wheel 101 rotates in the direction shown by the arrow 118a (i.e., clockwise and the direction of forward travel of a hypothetical vehicle to which the wheel 101 may be coupled), the area of the fins 106 that is contacted by air sweeping across the fins 106 is increased and the resistance to air flow across the fins 106 is reduced because of reduced air pressure across the fins 106. Accordingly, the mass flow rate of air over the fins 106 may be increased (as compared to a sweeping concave profile) and the heat transfer to the air may be increased. It is contemplated that the wheel 101 may also rotate in the counter-clockwise direction (i.e., as shown by arrow 118b). Although the particular illustrated embodiment includes forward sweeping fins 106, it is to be understood that not all embodiments include such a profile. Still referring to FIGS. 4A and 4B, the spokes 112 may include a slot 113 which may reduce the weight of the wheel 101.

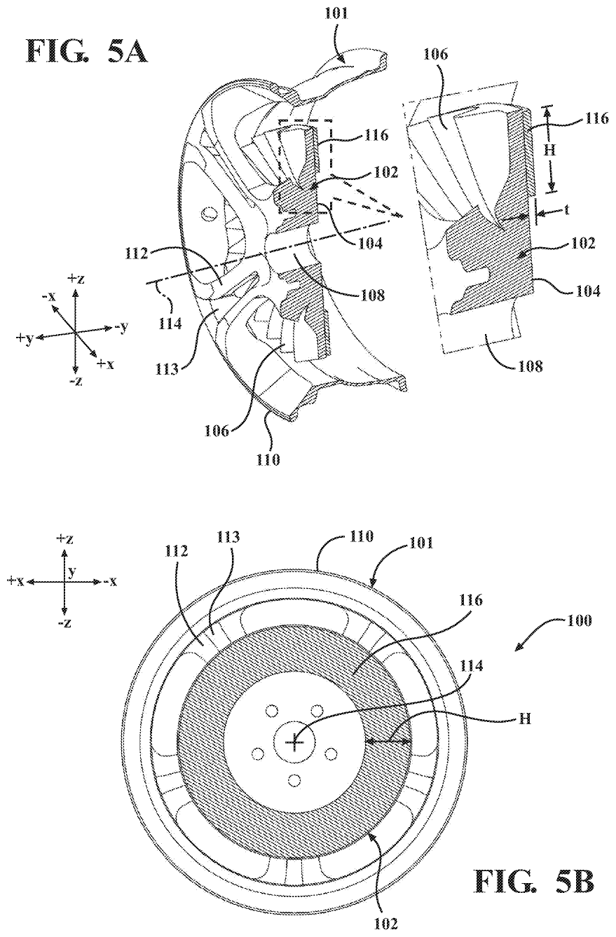

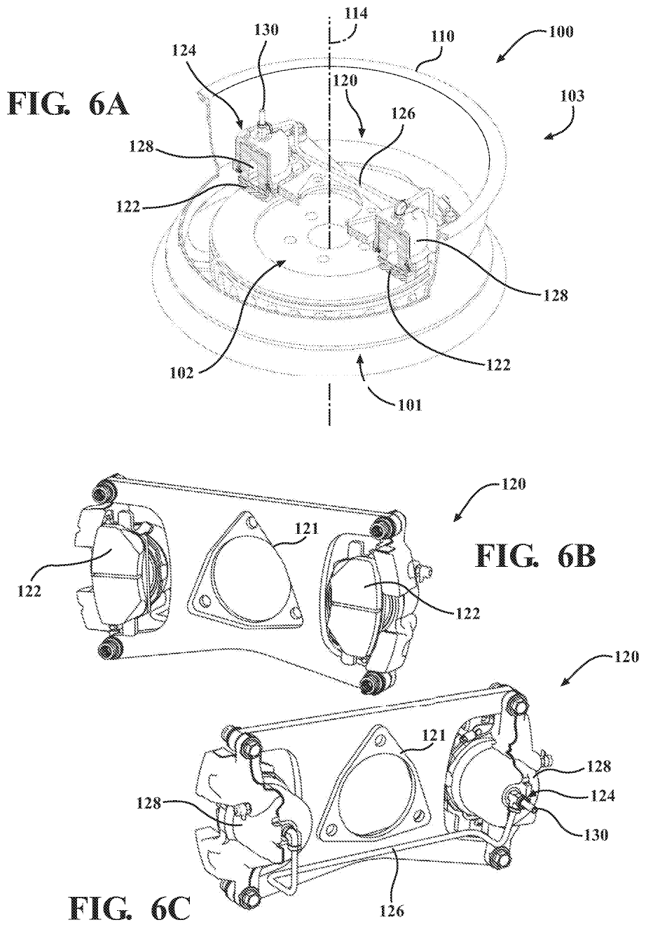

Referring now to FIGS. 5A and 5B, an embodiment of the wheel assembly 100 including the integrated brake rotor 102 having the plurality of fins 106, the braking surface 104, and a liner 116 are illustrated. The liner 116 is included as an external layer on the braking surface 104 of the brake rotor 102. The liner 116, also referred to herein as a coating, may be an alloy coating such as that described in U.S. Provisional Patent Application Nos. 62/635,744 and 62/810,680, and International Application Nos. PCT/US2019/019717 and PCT/US2020/019894, which are hereby incorporated by reference in their entirety. In some embodiments, the liner 116 is a light alloy such as aluminum, magnesium, or titanium. In some embodiments, the liner 116 is a layer comprising a nitrogen-containing alloy/compound such as, for example, a high-nitrogen content steel, Cr₂N, TiN, AlN, and the like, as described in greater detail in U.S. Provisional Patent Application Nos. 62/635,744 and 62/810,680, and International Application Nos. PCT/US2019/019717 and PCT/US2020/019894. The liner 116 may increase the friction between the brake rotor 102 and a braking mechanism such as a brake pad. The liner 116 may have a similar coefficient of thermal expansion as the brake rotor 102, the wheel 101, or other components of the wheel assembly 100. Accordingly, the liner 116 and the brake rotor 102 or other components may expand similarly as friction heats the brake rotor 102 and the liner 116 during application of a braking mechanism (e.g., the brake pad 122, as shown in FIG. 6B). Additionally, the liner 116 may improve the wear characteristics of the wear surfaces, i.e., the braking surface 104, of the wheel assembly 100.

As shown in the inset in FIG. 5A, which illustrates an enlarged view of a portion of the brake rotor 102, the liner 116 may extend a height H around the entire circumference of the brake rotor 102 and may be sized according to the size of a brake pad, for example, or other friction-causing device. The liner 116 may increase the useable life of the wheel assembly 100 and the braking system to which it may be selectively coupled. The liner 116 may have a thickness t in a vehicle-inward direction (i.e., the −y direction of the coordinate axis as shown in FIG. 5A) toward the interior of a hypothetical vehicle to which the wheel assembly 100 may be attached. The liner 116 may be configured to maintain a particular thickness for a given number of cycles of a brake system of a vehicle to which the wheel assembly 100 is attached. That is, the liner 116 may be configured to last for a certain number of brake applications and then be replaced. In some embodiments, the liner 116 is replaceable separately from the wheel assembly 100. In some embodiments, the entire wheel assembly 100 may need replacement after a particular number of brake cycles.

In some embodiments, the liner 116 may be an alloy layer on a metal (including metal alloys). The liner 116 may contact and overly at least a portion of the substrate, i.e., the base or brake rotor 102. The liner 116 may comprise a mechanically tough alloy having dissolved nitrogen and may having a substantially homogeneous composition. In embodiments, the composition of the liner 116 may be, by weight percent, 0.1 wt % to 2 wt % nitrogen (N). Further, the liner 116 may include a single phase nitrogen alloy. The wheel assembly 100 or components thereof may include a metal substrate having a substrate composition and a substrate interface. The substrate interface may include thereon a protective nitrogen containing alloy layer. It is contemplated that the alloy or overlying layer may be an iron containing alloy.

In some embodiments, the wheel assembly 100 and the liner 116 may be prepared using solid precursor materials having the desired dissolved nitrogen deposed to form the protective alloy layer on the substrate surface. Methods of forming may include exposing a liquid alloy having alloying elements that promote dissolution of nitrogen to a high partial pressure nitrogen atmosphere to induce high dissolved nitrogen, and then solidifying the alloy in a manner such that the dissolved nitrogen in the liquid alloy is substantially captured in the solid precursor material. In some embodiments, the methods further include avoiding any intermediate phase formation that has low nitrogen solubility and/or rapid solidification to prevent nitrogen loss. The form of the precursor solid may be micron sized powders. In some embodiments, the form of the precursor solid is a thin strip having a thickness of from 0.1 millimeters (mm) to 5 mm.

In embodiments, the wheel assembly 100 may be a composite article. An overlying layer of nitrogen containing alloy may be overlaid onto a substrate by processes wherein the nitrogen containing alloy precursor material is kept substantially solid during fabrication, thus preventing dissolved nitrogen loss. The methods may include providing a cold spray deposition process to deposit micron sized powder precursor having dissolved nitrogen, thereby forming the overlying layer. In some aspects, the methods include a joining process forming the overlying layer, wherein both a thin strip of precursor material and the substrate are kept substantially in solid state. In yet other aspects, the methods include a casting process, wherein a thin strip precursor is kept substantially in solid state and contacting a substantially liquid metal/alloy. Upon cooling, the liquid metal solidifies forming the substrate while the thin strip precursor forms the overlying layer.

“Precursor” as used herein means the material deployed to fabricate the nitrogen containing liner 116 (e.g., a protective layer) on a substrate, such as the brake rotor 102. In specific aspects, the precursor is the solid powder or the thin strip intended for making the layer. “Composite” as used herein means an article made up of several parts or elements. Specifically, the composite is an object having a substrate and the liner 116 intended to provide functionalities that are not otherwise provided by the individual elements alone. “Compound” as used herein, means a material formed by reactions between elements having a stoichiometric ratio, for example, Cr₂N, F₂N, TiN, and the like.

The addition of nitrogen may improve the strength, ductility, and impact toughness in austenitic steels, while the fracture strain and fracture toughness are not affected at elevated temperatures. The strength of nitrogen alloyed austenitic steels arises from three components: strength of the matrix, grain boundary hardening, and solid solution hardening. The matrix strength is not appreciably impacted by nitrogen, rather, the matrix strength correlates to the friction stress of the FCC (face centered cubic) lattice that is mainly controlled by the solid solution hardening of the substitutional elements like chromium and manganese. Grain boundary hardening, which occurs due to dislocation blocking at the grain boundaries, increases proportionally to the alloyed nitrogen content. The highest impact on the strength results from the interstitial solid solution of nitrogen. Nitrogen increases the concentration of free electrons promoting the covalent component of the interatomic bonding and the formation of Cr—N short range order (SRO). The occurrence of Cr—N SRO and the resultant interactions with dislocations and stacking faults are believed to play a major role in the deformation behavior of these alloys and can be tailored to enhance the strength, ductility, and impact toughness.

The composition and temperature strongly influence the stacking fault energy (SFE) and, in turn, the deformation mechanisms and strengthening behavior of austenitic steels. Increasing the SFE causes the active deformation mechanisms to change and is generally favored to achieve pure dislocation glide and enhanced toughness. Specifically, the effect of N additions on the SFE in Cr and Mn alloyed steels are reported to be non-monotonic, exhibiting a minimum SFE at about 0.4 wt % nitrogen. The decrease in SFE at low nitrogen contents is believed due to the segregation of interstitial nitrogen atoms to stacking faults. However, at higher nitrogen contents, the SFE increases as the bulk effect of interstitial solid solution becomes more pronounced. The formation of nitrides, such as Cr₂N, TiN, AlN, and the like, at elevated nitrogen content affects the distribution of alloying elements within the lattice and, in turn, diminishes the bulk effect of interstitial solid solution and the SFE. The formation of nitrides such as Cr₂N occurs when the nitrogen content goes beyond certain threshold value (depends on the overall composition of the alloy) and should be discouraged to take advantage of the interstitial solid solution hardening phenomenon described above.

High nitrogen containing austenitic steels also exhibit excellent resistance to atmospheric corrosion. However, the corrosion resistance is also strongly influenced by the nitrogen content. At low nitrogen contents, the formation of σ phase (an intermetallic compound with Cr) at the grain boundaries as well as the formation of nitrides such as Cr₂N at high nitrogen content are detrimental to the corrosion resistance of these steels. Optimal corrosion resistance can be achieved if all nitrogen is in solid solution, i.e., no nitrides are precipitated.

An optimal combination of toughness and corrosion resistance can be achieved by limiting the nitrogen content within a range, wherein a substantially or completely precipitation free homogeneous microstructure with nitrogen in solid solution form can be obtained. This range of dissolved nitrogen depends on other alloying elements present in the alloy as well as the process thermal history, which is discussed in more detail herein. Reductions in toughness and corrosion resistance may occur rapidly as the nitrogen content either decreases or increases from a desired range. As will be appreciated, the widely used industrial techniques such as nitriding or nitride PVD coatings cannot provide the liner 116 with homogenous nitrogen content on a substrate, wherein the nitrogen is in the desirable solid solution state. During nitriding, the nitrogen content will vary considerably at the surface forming compounds having high nitrogen to a very low level toward the core. In the case of nitride sputter coating, a coating may be made of brittle compounds even though the composition may mostly stay relatively uniform across a layer.

One approach to obtain a homogeneous dissolved nitrogen content in a metallic alloy, specifically in austenitic steel is to: (i) dissolve the nitrogen into the alloy in liquid state; and (ii) subsequently solidify the alloy without losing the dissolved nitrogen during solidification. However, both the tasks have their own challenges. For example, the nitrogen solubility in liquid iron at atmospheric pressure is very low (0.045 wt % at 1,600° C.). Nitrogen in liquid alloy increases by the square root of the partial pressure (Sievert's square root law). Hence, to introduce higher nitrogen into liquid iron/steel, melting should be done using a high pressure nitrogen environment. Nitrogen alloying in the molten state may be achieved by high pressure induction or electric arc furnaces, pressure electro slag remelting furnace (PERS), and plasma arc and high-pressure melting with hot isostatic processing (HIP) or the like.

The addition of certain elements such as chromium, manganese vanadium, niobium, and titanium increases the nitrogen solubility, while the addition of elements such as carbon, silicon, and nickel reduces the nitrogen solubility. Hence, in order to induce high nitrogen concentrations into the melt, chromium and manganese can be added and nickel should be avoided. Furthermore, in some aspects, elements such as vanadium, niobium, and titanium are absent or present in insignificant amounts as they are powerful nitride formers.

The production of high nitrogen containing austenitic steels by prior methods requires a balanced control of the alloy composition and precise adjustment of the melting and solidification conditions. Toughness and corrosion resistance of such alloys can also be exploited to provide protective layers on articles as an effective solution to the problems associated with traditional nitriding and nitride coatings.

The wheel assembly 100 may comprise the liner 116 and a base. It should be understood that reference to the base may refer to the brake rotor 102 and, specifically, the braking surface 104 of the brake rotor 102. When the brake rotor 102 is integrated with the wheel 101, the base may refer to composition of both the brake rotor 102 and the wheel 101. The base and the liner 116 may have a metallurgical bond at an interface of the base and the liner 116. The dissolved nitrogen content within the liner 116 may be uniform and may be higher than the solubility limit of nitrogen in the base in its liquid state at atmospheric pressure. The liner 116 may be devoid of a nitride compound or nitride compound layer such as that which occurs in nitriding or nitride coating processes. Although, the desired dissolved nitrogen content will vary from one application to another, the nitrogen content may be adjusted such that undesirable precipitation formation is avoided to improve mechanical toughness and corrosion resistance. The nitrogen content in the liner 116 may be between 0.1 wt % and 2.0 wt %. In some embodiments, the nitrogen content in the liner 116 is between 0.4 wt % and 0.9 wt %.

The base may be a surface that is flat, substantially flat, curvilinear, or any other desired shape with concave, convex, or other surface configuration as described herein. The base may be or include a metal alloy. Illustrative examples of metal alloys include, but are not limited to, alloys that include Al, Si, B, Cr, Co, Cu, Ga, Au, In, Fe, Pb, Mg, Ni, C, a rare earth (e.g. La, Y, Sc, or the like), Na, Ti, Mo, Sr, V, W, Sn, Ur, Zn, Zr, or any combination thereof. In some aspects, the base includes Al or an alloy of Al. In some embodiments, the base includes Al from 80 wt % to 100 wt %. In some embodiments, the base includes a cast iron or a steel. In some embodiments, the base includes a Ti alloy. In some embodiments, the base includes a reinforced composite, including one of the above metal alloy matrix and fiber/particulate reinforcement. Illustrative examples of reinforcement phase include SiC, Al₂O₃, or C. In some embodiments, the volume fraction of the reinforcement phase is between 5% and 75%. In some embodiments, the volume fraction of the reinforcement phase is between 20% and 35%. In some embodiments, the volume fraction of the reinforcement phase is between 40% and 55%.

The liner 116 includes a metal or metal alloy with dissolved nitrogen at a desired concentration so as to provide desired functionality in terms of toughness and corrosion resistance. The liner 116 may be an austenite metal alloy and, in some embodiments, includes Fe as a predominant metal in the alloy. The metal alloy may include N and Fe, referred to herein as an FeN layer, whereby the N is present at a sufficient amount so as to promote an austenite structure. In some embodiments, N present at a weight percent from 0.05 wt % to 2 wt % or any value or range therebetween. In some embodiments, N is present at a weight percent from 0.1 wt % to 1.5 wt %, in some embodiments from 0.2 wt % to 2 wt %, in some embodiments from 0.2 wt % to 1.9 wt %, in some embodiments from 0.3 wt % to 1.9 wt %, in some embodiments from 0.3 wt % to 1.8 wt %, in some embodiments from 0.4 wt % to 2 wt %, in some embodiments from 0.4 wt % to 1.9 wt %, in some embodiments from 0.4 wt % to 1.8 wt %, or in some embodiments from 0.4 wt % to 1.5 wt %. The amount of N may be dependent on the desired fraction of austenite in the final material and the final composition of the material.

As discussed herein, in embodiments including the liner 116, the liner 116 may include Fe, which may be present at a predominant amount at a weight percent of 51 wt % or greater, in some embodiments at a weight percent of 52 wt % or greater, and in some embodiments at a weight percent of 55 wt % or greater. With Fe as a predominant metal, an alloy may be a solid solution with FCC structure, at the temperature at which the material is expected to be used, in some embodiments from −150° C.±5% to 1,000° C.±5%. The amount of N and other elements is designed to promote the FCC structure of the metal alloy such that this structure is promoted and maintained at temperatures up to 1,000° C.±5%. As such, the metal alloy in some embodiments is substantially 100% FCC structure and in some embodiments 99% FCC structure. In some embodiments, a metal alloy of the liner 116 is 95% FCC structure or greater. In some embodiments, a metal alloy of the liner 116 is 50% FCC structure or greater. In some embodiments, the liner 116 alloy is free of other structures such as FCC. It is to be appreciated that the wheel 101 and the brake rotor 102 themselves may also include a similar composition to that of the liner 116 described herein. Thus, the wheel 101 and the brake rotor 102 may also comprise a FeN alloy.

In addition to nitrogen, the liner 116 may include one or more other elements that will promote FCC structure. For example, the liner 116 may include Mn. When present, Mn may be provided at a weight percent from 0 wt % to 35 wt %. In some embodiments, the weight percent of Mn is less than 30 wt %. In some embodiments, the weight percent of Mn is from 19 wt % to 27 wt %. In some embodiments, the weight percent of Mn is from 20 wt % to 26 wt %. The presence of N in such alloys serves to promote and stabilize a desired FCC structure even when the amount of Mn or other FCC promoting metal is less than 20 wt %. As such, the dissolved N and Mn work in concert to promote austenitic structure to the protective layer metal alloy. The liner 116 may include Ni, which also promotes austenitic structure. When present, Ni may be provided at a weight percent from 0 wt % to 20 wt %. Since Ni reduces the N solubility in the liner 116, the Ni may be from 0 wt % to 5 wt %. The liner 116 may include C. When present, C may be provided at a weight percent from 0 wt % to 0.2 wt %. While C improves N solubility, it also reduces the toughness of the resulting alloy. The C may be present in the alloy from 0 wt % to 0.1 wt %.

Cr may be included in the provided N alloy. In order to control the phase of the liner 116, the ferrite stabilizing effect of Cr may be countered by adjusting the amount of N and/or Mn, both of which serve as austenite stabilizers. Further, the substrate material properties may also be taken into consideration in designing the provided alloy. For example, if the substrate is an aluminum alloy which has a FCC structure, the liner 116 alloy may be 100% austenite (FCC) phase in order to match the thermal coefficient of expansion of the base and other components of the wheel assembly 100. When the base is a ferritic cast iron or steel, a mixture of austenite and ferrite structure may be chosen. In some embodiments, a protective layer is 100% austenite, in some embodiments 90% austenite or greater, in some embodiments 80% austenite or greater, in some embodiments 70% austenite or greater, in some embodiments 60% austenite or greater, and in some embodiments 50% austenite or greater.

The liner 116 may include one or more other metals. The liner 116 may include molybdenum (Mo). When present, Mo may be provided at a weight percent of 0 wt % to 5 wt %. A protective layer metal alloy may include aluminum (Al). When present, Al may be provided from 0.01 wt % to 10 wt %. In some embodiments, Al is present at or less than 10 wt %, in some embodiments at or less than 8 wt %, and in some embodiments at or less than 6 wt %.

Still referring to FIGS. 5A and 5B, methods of forming the liner 116 on the wheel assembly 100 may include one or more steps including, but not limited to, providing a solid precursor alloy with a dissolved nitrogen content substantially higher than the solubility limit of the alloy in its liquid state at atmospheric pressure, and disposing the solid precursory alloy on one or more components of the wheel assembly 100. The solid precursor material may be obtained by atomizing the liquid alloy containing dissolved nitrogen in the desired range and forming micron sized solid powders, or directly casting into a thin strip format from liquid alloy containing dissolved nitrogen in the desired range. Prior to powder atomization or strip casting, the liquid alloy composition is adjusted such that δ-ferrite formation is substantially reduced during solidification, and further the liquid alloy is prepared under a high nitrogen pressure ensuring enhanced dissolved nitrogen in the liquid. The nitrogen pressure in the melting chamber in some embodiments is kept between 0.2 MPa and 10 MPa and in some embodiments between 0.5 MPa and 6 MPa. The inherent rapid solidification associated with powder atomization and strip casting ensures the retention of the dissolved nitrogen in the solid precursor and microstructure homogeneity. The powder atomization may be carried by compressed nitrogen gas jet, which may be referred to as gas atomization. The powder atomization may be carried out by water jet, which may be referred to as water atomization.

Disposing the alloy precursor on the components of the wheel assembly 100 may be achieved either manually by placing the substrate in a desired manner or via an automated system that disposes the substrate in accordance to a predetermined program. The latter approach may be used, for example, in industrial implementation. The surface quality of the precursor N alloy may be considered as a factor in the joining process. Two types of bonding can occur between the substrate and the protective layer. In the case of nitriding, wherein the protective layer grows on the substrate through diffusion process, resulting bonding may be referred to as metallurgical bonding. Similarly, fusion joining as is achieved in this disclosure may also establish a metallurgical bond. On the other hand, deposition processes such as plasma spraying establish a mechanical adhesion, wherein extensive surface preparation such as grit blasting or surface grooving is necessary for good adhesion.

Additionally, a strip precursor may be disposed onto one or more surfaces of the wheel assembly 100 (e.g., at the interface between the liner 116 and the wheel assembly 100). The strip precursor may be joined to the substrate and may remain substantially solid during the joining process, ensuring the retention of the dissolved nitrogen in the liner 116. The joining process may be a linear friction welding process, wherein the interfacial layer may soften into a plastic state due to oscillating linear motion between the precursor and the substrate and upon cooling may form a metallurgically bonded joint. In some embodiments, the strip precursor comprises preformed anchors and is deposed onto a molten alloy, the latter upon solidification forms the substrate. The embedment of the anchors into the solid substrate ensures the adhesion to the substrate. The molten alloy temperature may be below the melting point of the precursor alloy so that the precursor does not appreciably melt and lose its dissolved nitrogen, although surface interaction may promote metallurgical bonding.

In some embodiments, a solid powder precursor may be deposed onto the substrate at high velocity which may form a metallurgical bonding with the wheel assembly 100 upon impact to form the liner 116. This can be suitably achieved by a supersonic nozzle, wherein the solid powder precursor is injected into a high velocity gas jet which accelerates the powders. The gas may be heated to increase the powder temperature, but to keep it below the melting point. Additional energy may be provided onto the powder or both the substrate and the powder. However, the precursor and the layer remain below the melting point throughout the forming process.

In embodiments, the energy source may be a laser, an electron beam, a plasma, or an infrared source. The deposition nozzle may move forward according to CAD data or tool path generated by a control system to build the nitrogen alloy protective layer over the substrate. The nozzle movement can be done manually.

In some embodiments, a logic gate may determine the need for additional thickness of the liner 116 (e.g., more layers). If an additional layer is required, one or more of the previously listed steps may be repeated. When the powder precursor is used, only thin layers (˜micrometers) may be built in one pass and hence the process is repeated multiple times to build an appreciable thickness of the protective alloy layer. If the desired layer thickness has been fabricated, the composite object may be cooled to ambient temperature. It is to be understood that the steps described herein are not necessarily discrete and that there may be overlap between some steps leading to a continuous fabrication process. Additionally, one or more of the above steps or components thereof may be omitted.

In yet other embodiments, a strip precursor may be disposed onto the wheel assembly 100 and may be subject to a mechanical load and oscillating movement with an amplitude sufficient to generate friction and heat along the interface. The substrate may be held stationary and the strip precursor may make the oscillating movement to generate friction. The mechanical friction and heat along the interface may generate a thin plastic zone at the interface. Much of this plasticized material may be removed from the weld, as flash, because of the combined action of the applied force and part movement. Surface-oxides and other impurities may be removed, along with the plasticized material, which may allow metal-to-metal contact between parts and enable a metallurgic joint to form. The process may be referred to as friction welding. The motion between the substrate and the strip precursor can be rotary depending upon the geometry. Such an effect may take place in the solid state and involve no melting of the parts to be joined, ensuring the retention of the dissolved nitrogen in the protective alloy layer. The strip precursor thickness may be between 0.5 mm and 10 mm, and may be between 0.5 mm and 2 mm. Further, the strip precursor may be cut into a size that can either cover a portion of a surface of the wheel assembly 100 or entirely cover a surface of the wheel assembly 100. To obtain a strong joint, a specific power input should be exceeded. The frequency, amplitude, and pressure have an effect on this parameter, which was defined as:

$$w = \frac{∝ fP}{2 π A} ,$$

with α being the amplitude; f the frequency; P the pressure; and A the interface area. From this relationship, it can be seen that the power input can be increased by increasing the frequency, amplitude, or pressure. For example, to join the nitrogen alloy strip precursor with 40×25 mm area onto an aluminum substrate, the parameters may be: frequency 30 Hz to 60 Hz; amplitude±2 mm to ±3 mm; pressure 80 MPa to 150 MPa; and time 7 seconds to 25 seconds.

For a large article, the mechanical force required to make a friction weld across a large area may be difficult to control. Additional manufacturing methods may include use of a solid nitrogen alloy precursor having anchors deposed adjacent to a liquid or semi-solid metal/alloy substrate such that the anchors are immersed in the fluid. The melting point of the fluid metal/alloy point may be lower than that of the nitrogen alloy layer such that the precursor solid does not melt. Upon solidification, the fluid may form the substrate and the precursor may become the protective layer. As one example, the solid precursor may be a nitrogen alloy steel and the substrate may be an aluminum alloy. Both wear and corrosion resistance of an aluminum article may be enhanced using such a process. The contact time between the solid precursor and the substrate fluid may be minimized to prevent any detrimental reaction and intermetallic formation between the precursor and the substrate alloy. The fluid substrate metal may be supplied from a bottom of a casting assembly so that it comes into contact with the solid precursor at an end of the casting assembly, and upon contact immediately solidifies minimizing the interfacial reaction. The fluid metal may be supplied by an electromagnetic pump from the bottom of a casting assembly having the precursor solid disposed at a top of a mold cavity. The substrate alloy may be a semi-solid that behaves like a fluid due to heavy shear action during the feeding process. Thus, the overall temperature of the fluid may be at a few hundred degrees C. below the melting point, but can be filled into the cavity easily. This may further limit the surface interaction between the precursor and the substrate fluid. Such a casting process may be referred to as thixocasting.

In embodiments, manufacturing the liner 116, i.e., coating, on the wheel assembly 100 may include use of a cold spray nozzle operably connected to a gas heater and a powder feeder. A gas inlet may supply gas to the gas heater at high pressure. This may be referred to as process gas. Further, gas may also be supplied to the powder feeder. This may generally referred to as carrier gas. The process gas pressure may be the same as the carrier gas pressure, however, they may operate at different pressures. The process gas pressure may be 100 pounds per square inch (PSI)±10%, 200 PSI±10%, 300 PSI±10%, 400 PSI±10%, 500 PSI±10%, 600 PSI±10%, 700 PSI±10%, 800 PSI±10%, or higher. The process gas pressure may be from 100 PSI to 800 PSI, or any value or range therebetween. In some embodiments, the process gas may be 40 scfm±10% (standard cubic feet per minute), 50 scfm±10%, or 60 scfm±10%. The process gas may be heated by a gas heater prior to entering into a convergent and divergent nozzle, wherein the gas attains very high velocity in the divergent section. There are many known variants of the nozzle geometry in the art. In some embodiments, the nozzle speed is 5 mm/s±10%, 10 mm/s±10%, 15 mm/s±10%, and 20 mm/s±10%. The process gas temperature may be 50° C., 100° C., 200° C., 300° C., 400° C., 500° C., 600° C., 700° C., 800° C., 900° C., or higher. The process gas temperature may be from 50° C. to 900° C., or any value or range therebetween. The nitrogen alloy precursor powder may be supplied by the powder feeder and may be carried by the carrier gas and may be delivered to the process gas stream. The precursor powder can be delivered in a convergent section of a nozzle or a divergent section of a nozzle. The powder feeder temperature may be 50° C., 100° C., 200° C., 300° C., 400° C., 500° C., 600° C., 700° C., 800° C., 900° C., or higher. The carrier gas pressure may be 100 PSI±10%, 200 PSI±10%, 300 PSI±10%, 400 PSI±10%, 500 PSI±10%, 600 PSI±10%, 700 PSI±10%, 800 PSI±10%, or higher. The powder feeder rate may be between 3 g/min (grams per minute) and 10 g/min. In some embodiments, the powder feeder rate is between 6 g/min and 8 g/min. The cycle time may be between 1 minute and 5 minutes. In some embodiments, the cycle time may be between 3 minutes and 4 minutes. The carrier gas pressure may be from 100 PSI to 800 PSI, or any value or range therebetween. In some embodiments, the process gas may be between 1 scfm and 5 scfm and, in some embodiments, the process gas may be between 1 scfm and 2 scfm. The precursor solid powder having the dissolved nitrogen absorbs heat from the process gas as well as accelerates towards the substrate due to drag force exerted by the process gas. Unlike conventional plasma spraying, the bonding occurs through a process termed as “adiabatic shear instability” that leads to a metallurgical bonding. The powder particle must attain a required velocity to form a metallurgical bond with substrate, which is known as the critical velocity in the art. The critical velocity depends on the precursor powder properties, size, temperature as well as the properties of the substrate and substrate temperature. The process parameters are adjusted accordingly to provide critical velocity to maximum number of the particles in the particle stream. For example, a nitrogen alloy powder having 0.7 wt % N, 19 wt % Mn, 15 wt % Cr and the rest iron with powder size ranging from 20 μm to 45 μm requires a critical velocity in excess of 500 m/s at 500° C. particle temperature to successfully form a consolidated alloy layer. In some embodiments, the precursor powder size is between 5 microns and 250 microns, in some embodiments between 5 microns and 150 microns, and in some embodiments between 10 microns and 75 microns. The particle stream may be directed onto the substrate and upon impact and bonding, a protective layer is consolidated. The powder temperature as well as the target temperature remains substantially below the melting point of the alloy, thereby retaining the alloyed nitrogen in the protective layer. Thus, the coating layer fabrication can be carried in open atmosphere without requiring a high pressure nitrogen environment. Further, the spray nozzle may be operably connected to a robot that can traverse the nozzle according to a preprogrammed path. Further, the protective layer can be built layer by layer until the required thickness is achieved. Depending upon the application, in some embodiments the thickness of the layer is 5 microns, in some embodiments 10 microns±10%, in some embodiments 100 microns±10%, in some embodiments 1,000 microns±10%, and in some embodiments greater than 1,000 microns. The ancillary componentry such as the power supply, control systems, auxiliary heating source, and gas tanks are not shown and their inclusion in the system is understood. The manufacturing system can be configured in a variety of ways. For example, a CNC motion system can be utilized instead of a robot. Further, another robot can be deployed to manipulate the substrate. The entire system can be enclosed in a controlled environmental chamber.

In some embodiments, a nitrogen alloy layer may be fabricated in various forms. The nitrogen content across the entire layer may be uniform. Some embodiments may include a protective layer that has two different nitrogen contents along the thickness. This can be achieved by utilizing two different powder precursors with different nitrogen content. Additionally, the nitrogen content can be progressively varied along the thickness by deploying several powders with progressively varying nitrogen content.

Referring now to FIGS. 6A, 6B, and 6C, an embodiment of a wheel and brake assembly 103 including the wheel assembly 100 and a mechanical braking assembly 120 is shown mechanically coupled to the wheel assembly 100 and in isolation, respectively. The mechanical braking assembly 120 includes a brake pad 122 and an actuator 124 that includes an actuation line 126 and a brake pad piston 128. The particular illustrative embodiment shown in FIGS. 6A, 6B, and 6C includes two pistons 128 individually mechanically coupled to two brake pads 122. The actuation line 126 may be configured to receive, for example, hydraulic fluid. The hydraulic fluid may be actuated by one or more external systems to fill a chamber of the piston 128 to actuate the brake pad 122 to extend parallel to the rotation axis 114 and contact the brake rotor 102 to inhibit the rotation of the wheel assembly 100. In embodiments, the actuation line 126 may include one or more ports such as the port 130 for sending and/or receiving, i.e., applying, a hydraulic fluid to an external system and/or for recycling used hydraulic fluid. While the particular illustrated embodiment shows two pistons 128 and two brake pads 122, it is contemplated that the mechanical braking assembly 120 may include one or more pistons 128 and one or more brake pads 122. Moreover, it is contemplated that multiple pistons 128 could be used to actuate a single brake pad 122 and that, conversely, multiple brake pads 122 may be actuated by a single piston 128. Additionally, it is contemplated that in some embodiments, the individual chambers of the pistons 128 are fluidly coupled to the actuation fluid system in parallel or in series.

As shown in FIGS. 6A, 6B, and 6C, the mechanical braking assembly 120 includes a coupling mechanism 121 for coupling the mechanical braking assembly 120 to a vehicle. The mechanical braking assembly 120 is configured to remain stationary with respect to a vehicle while the wheel assembly 100 rotates relative to a vehicle, thereby creating relative rotational motion between the mechanical braking assembly 120 and the wheel 101. Thus, upon actuation of the actuator 124, the mechanical braking assembly 120 may actuate to inhibit rotation of the wheel 101.

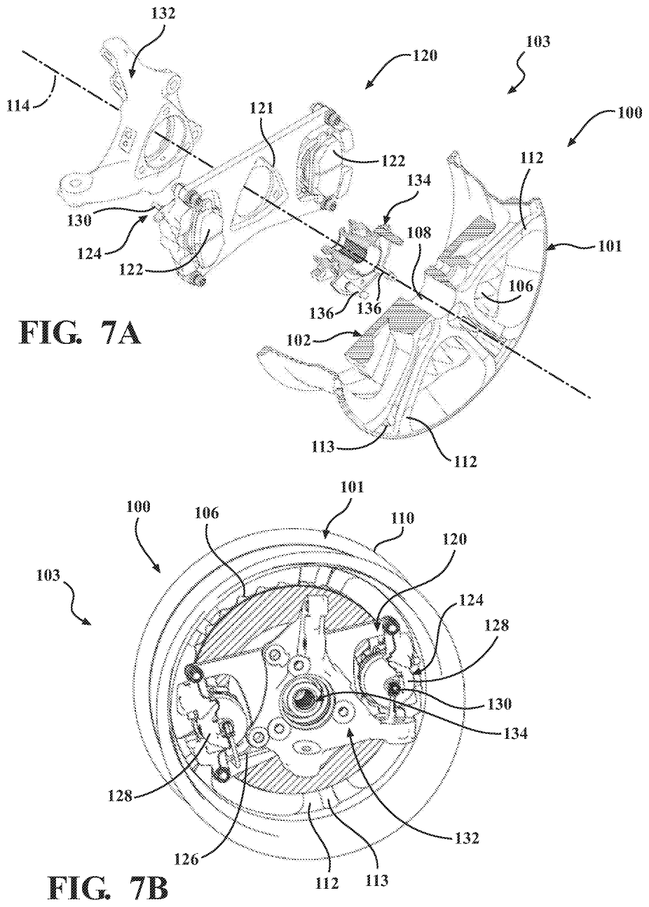

Referring to FIGS. 7A and 7B, a vehicle knuckle 132 is shown in relation to the mechanical braking assembly 120. The vehicle knuckle 132 and the mechanical braking assembly 120 may be configured to couple to the wheel 101 at a wheel bearing 134. The wheel bearing 134 may be configured to couple to a vehicle axle (not shown) and may include a plurality of bolts 136 for selectively coupling the wheel assembly 100 to the axle and the mechanical braking assembly 120 and the vehicle knuckle 132 to the wheel assembly 100. The vehicle knuckle 132 may include multiple other mechanical interfaces for connecting the vehicle knuckle 132 to other systems (e.g., the steering system and the like).

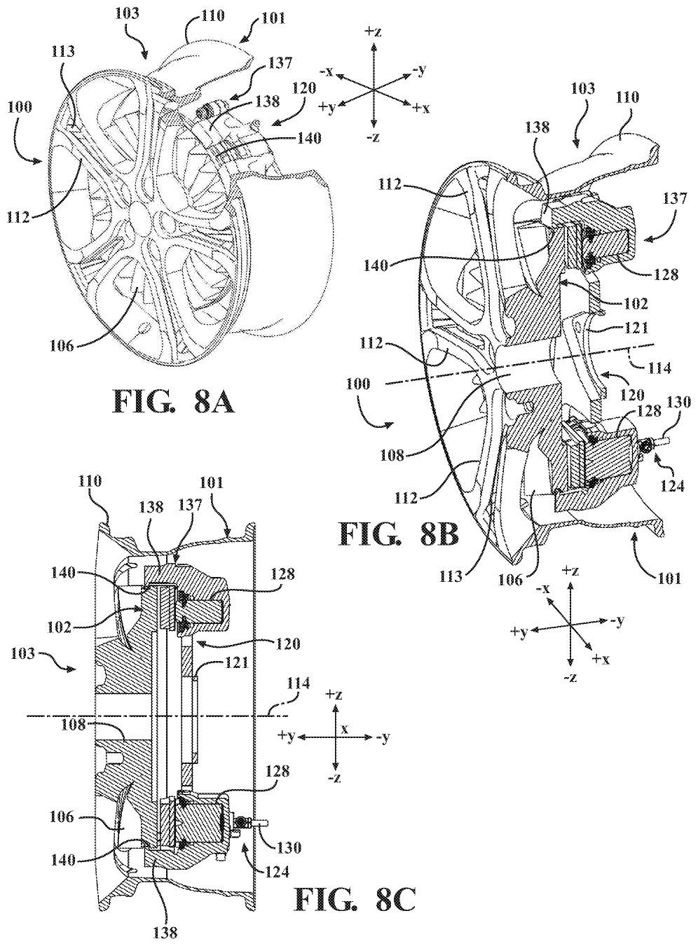

Referring to FIGS. 8A, 8B, and 8C, in some embodiments, the mechanical braking assembly 120 may include a tongue-and-groove assembly 137 that includes a tongue 138 that extends in a vehicle-outward direction (i.e., the +y direction of the coordinate axis) and radially inward into a groove 140 formed in the brake rotor 102 of the wheel assembly 100. The tongue 138 and the groove 140 may cooperate to inhibit flexure of the wheel assembly 100 and the mechanical braking assembly 120 as the wheel 101 turns and is subjected to various forces. In other words, the tongue 139 and the groove 140 cooperate to align the mechanical braking assembly 120 and the wheel 101. In embodiments, the tongue 138 may be integral with the brake rotor 102 and/or may be composed of the same material as the wheel 101 and components thereof. For example, the tongue 138 may be an alloy such as, for example, an aluminum or a magnesium alloy. The groove 140 may be a groove or channel that extends radially inward from an outermost radius of the brake rotor 102 toward the hub 108.

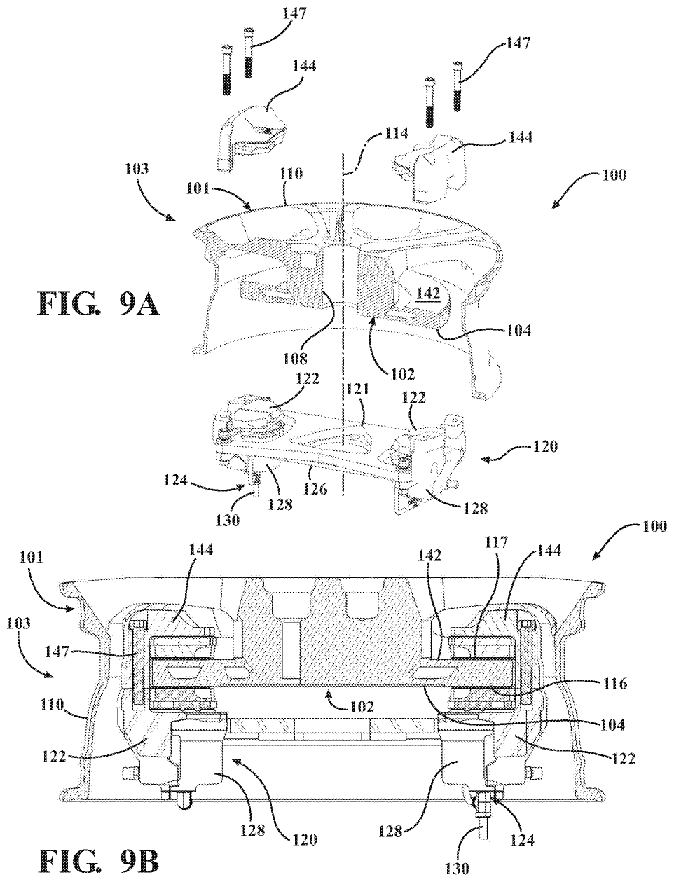

Referring to FIGS. 9A and 9B, some embodiments of the wheel assembly 100 include a second braking surface 142 on the brake rotor 102. The second braking surface 142 may be opposite the braking surface 104 of the brake rotor 102. A second brake pad or a brake caliper 144 may be configured to contact the second braking surface 142 causing friction and inhibiting rotational motion of the wheel assembly 100 about the rotation axis 114. The second brake pad or brake caliper 144 may be secured to the brake mechanical braking assembly 120 by a plurality of bolts 147. The second brake pad or brake caliper 144 may be actuated, for example, by a spring that may be coupled to an actuation mechanism, for example, the actuator 124, such that, upon application of a vehicle brake, the actuator 124 actuates the second brake pad or brake caliper 144 to inhibit rotational motion of the wheel 101. In embodiments, the second braking surface 142 and the braking surface 104 may sandwich the plurality of fins 106. A liner 117 may also be provided on a portion of the second braking surface 142. The disclosure herein regarding the liner 116 is equally applicable to the liner 117. As such, the liner 117 may be formed in the same manner as the liner 116 and include the same composition of the liner 116 as disclosed herein. For example, the liner 117 may include Fe and N, and referred to as a FeN layer. In an embodiment, the liner 117 may be identical to the liner 116 or the liner 117 may have a different material composition than the liner 116.

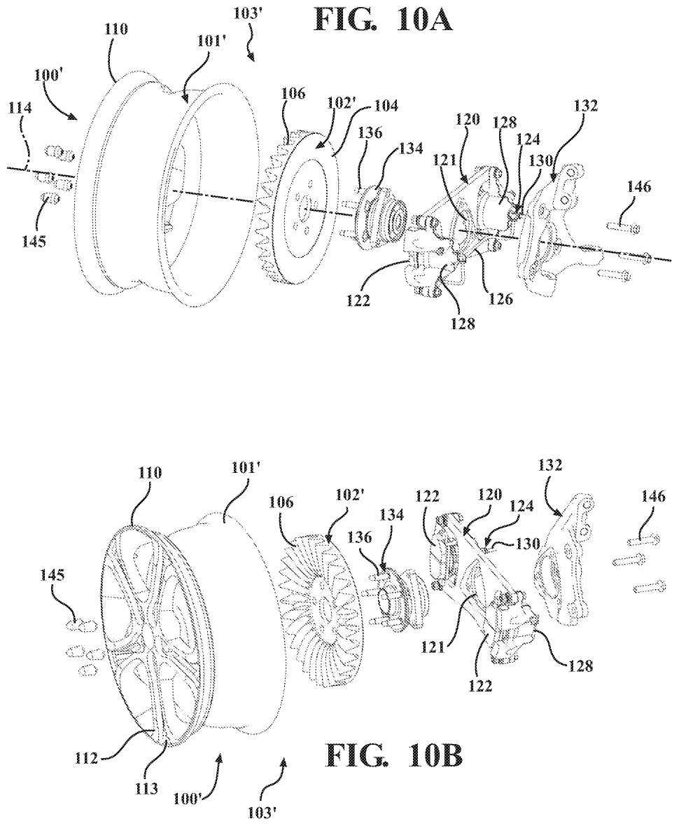

FIGS. 10A and 10B shows an embodiment of a wheel and brake assembly 103′ including a wheel assembly 100′ and the mechanical braking assembly 120. Throughout the ensuing description, like reference numerals will be used across different embodiments to indicate like parts. The wheel assembly 100′ includes the wheel 101 and a brake rotor 102′ that is not integrated with the wheel 101, as opposed to the brake rotor 102, which is integrated with the wheel 101. That is, the brake rotor 102′ and the wheel 101 may be separate parts that are constructed separately and are not monolithic. In embodiments in which the brake rotor 102′ and the wheel 101 are constructed separately, the brake rotor 102′ and the wheel 101 may be selectively coupled with the one or more bolts 136 extending from the wheel bearing 134. The bolts 136 may be secured to the wheel 101 by associated lug nuts 145 forming a plurality of lug-nut bolt pairs. In other embodiments, the brake rotor 102′ and the wheel 101 may be secured using other mechanisms such as a lock and key. The mechanical braking assembly 120 and the vehicle knuckle 132 may be coupled to the wheel bearing 134 using one or more threaded fasteners 146. The brake rotor 102′ and the wheel 101 may be constructed separately by forging, for example, and be made from the same material.

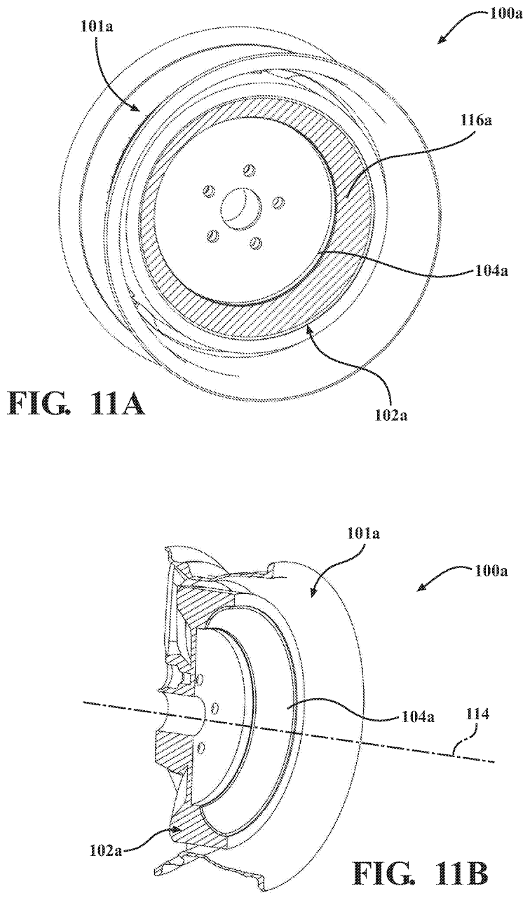

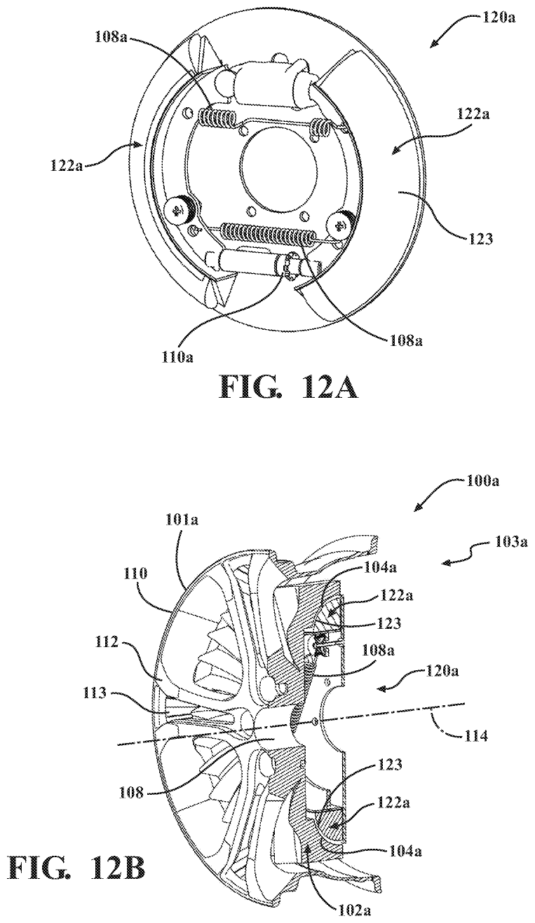

Referring now to FIGS. 11A, 11B, 12A and 12B, an embodiment of a wheel and brake assembly 103a is shown including a wheel assembly 100a and a mechanical braking assembly 120a. The wheel assembly 100a includes a wheel 101a and a brake rotor 102a having including a braking surface 104a with a contoured profile that is configured to match a contoured profile of a brake shoe 122a lined with a brake pad, such as 122. The brake shoe 122a is part of the mechanical braking assembly 120a. In some embodiments, the braking surface 104a may include a liner 116a. In some embodiments, the liner 116a may comprise a light alloy such as aluminum, magnesium, or titanium. In some embodiments, the liner 116a is a layer comprising a nitrogen-containing alloy such as, for example, a high-nitrogen content steel, Cr₂N, TiN, AlN, or the like, as described in greater detail in U.S. Provisional Patent Application Nos. 62/635,744 and 62/810,680, and International Application Nos. PCT/US2019/019717 and PCT/US2020/019894. It is to be appreciated that the materials used for the liner 116 described herein, as well as the method for forming, is equally applicable to the liner 116a. Braking surfaces with a contoured profile, such as the braking surface 104a, have a larger surface area than the braking surface 104 of FIGS. 3A and 3B. Accordingly, for a given wheel assembly 100a, the braking surface 104a may exhibit greater friction between brake pads or brake shoes, and the braking surfaces, such as the brake pad 122, the brake shoes 122a, and the braking surface 104a, respectively, and thus more rapid deceleration and shorter stopping of the vehicle to which the wheel assembly 100a is attached. While the particular illustrative embodiment shows a contoured profile in the shape of an arc or curve, it is to be understood that any profile that increases the contact area between the braking surface 104a and the brake shoe 122a is considered. While the particular illustrative embodiment depicts the brake rotor 102a as being integral with the wheel 101a, it is to be understood that, in some embodiments, the brake rotor 102a and the wheel 101a could be separate components in the wheel assembly 100a.

The mechanical braking assembly 120a includes a pair of brake shoes 122a, each including a brake pad, such as the brake pad 122, one or more biasing springs 108a, and an actuator 110a. The actuator 110a actuates forcing the brake shoes 122a apart from one another radially such that the contact of the brake shoes 122a on the braking surface 104a of the brake rotor 102a inhibits rotation of the wheel 101a. The brake shoes 122a include an exterior surface 123 that extends at least partially around a circumference of the mechanical braking assembly 120a and is configured to contact the braking surface 104a upon actuation of the mechanical braking assembly 120a to inhibit rotation of the wheel assembly 100a. Upon actuation of the actuator 110a, the brake shoes 122a expand radially outward, thereby contacting the braking surface 104a of the brake rotor 102a. The biasing spring 108a may return the brake shoes 122a to their original position when the actuator 110a is released.

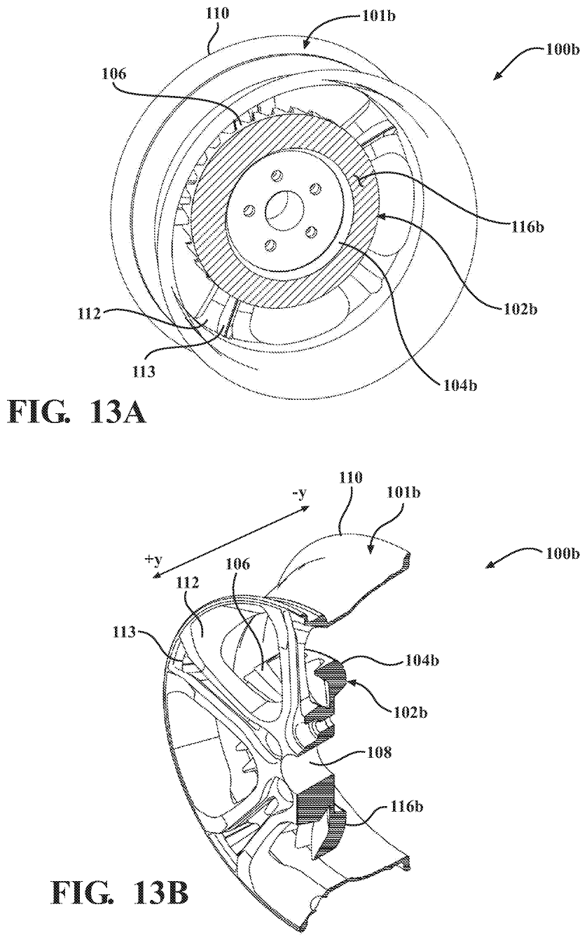

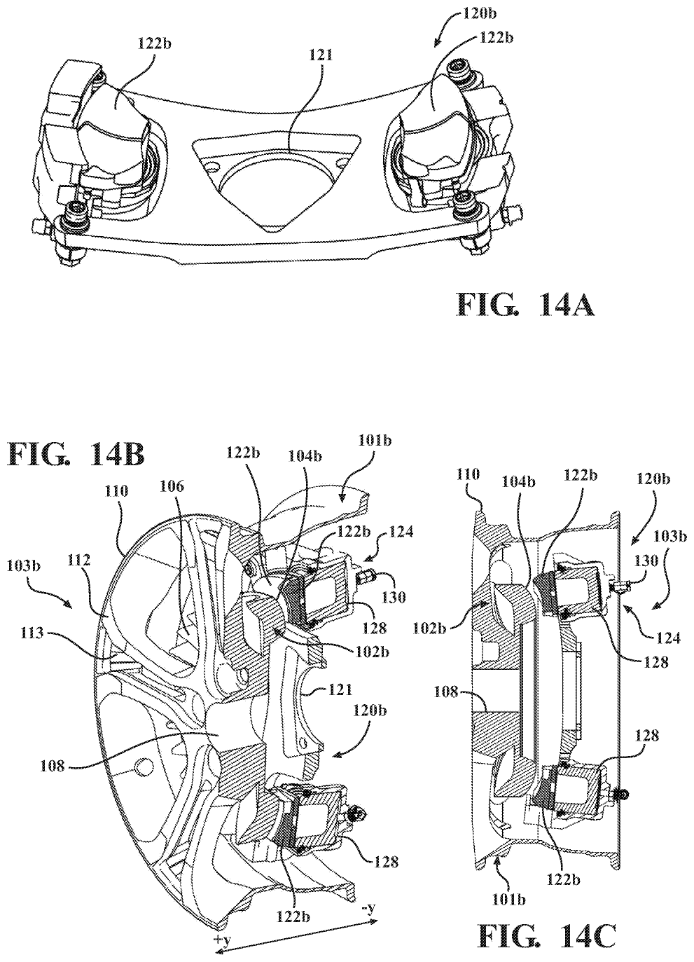

Referring now to FIGS. 13A, 13B, 14A, 14B, and 14C, components of an embodiment of a wheel and brake assembly 103b are shown including a wheel assembly 100b and a mechanical braking assembly 120b. The wheel assembly 100b includes a brake rotor 102b with a contoured braking surface 104b. In some embodiments, the contoured braking surface 104b may include a liner 116b, which is similar in composition and formation to the liner 116 and the liner 116a. The wheel assembly 100b is configured to correspond to the mechanical braking assembly 120b, which is similar to the mechanical braking assembly 120, including at least one brake pad 122b with a contoured profile that matches the contoured braking surface 104b of the brake rotor 102b. It is to be understood that the brake rotor 102b may be integral with the other components of the wheel 101b or may be a separate component that is formed separately from the wheel 101b and coupled thereto. In some embodiments, the contoured braking surface 104b may comprise a light alloy such as aluminum, magnesium, or titanium. In embodiments, the contoured braking surface 104b may be coated, for example, with a layer comprising a nitrogen-containing alloy such as, for example, a high-nitrogen content steel, Cr₂N, TiN, AlN, or the like, as described in greater detail in U.S. Provisional Patent Application Nos. 62/635,744 and 62/810,680, and International Application Nos. PCT/US2019/019717 and PCT/US2020/019894. The layer may increase friction between the brake pad 122b and the contoured braking surface 104b and may have a similar coefficient of thermal expansion as the brake pad 122b. The mechanical braking assembly 120b may perform as described herein. For example, actuation of an actuator, such as actuator 124, may cause the brake pad 122b to actuate to contact the contoured braking surface 104b to create friction between the contoured braking surface 104b and the brake pad 122b and inhibit rotation of the wheel assembly 100b. In the particular embodiment, the contoured braking surface 104b is an arc or curve with a profile that is convex in the vehicle inward direction, that is, in the −y direction as shown in FIGS. 13B and 14B. Generally, the contour increases the surface area of contact between the brake pad 122b and the contoured braking surface 104b, thereby increasing friction between the brake pad 122b and the contoured braking surface 104b. It is to be understood that the contoured braking surface 104b could take any profile such that the brake pad 122b includes a complementary profile and the surface area is increased as compared to a flat profile. The mechanical braking assembly 120b actuates similarly as described herein with respect to the mechanical braking assembly 120.

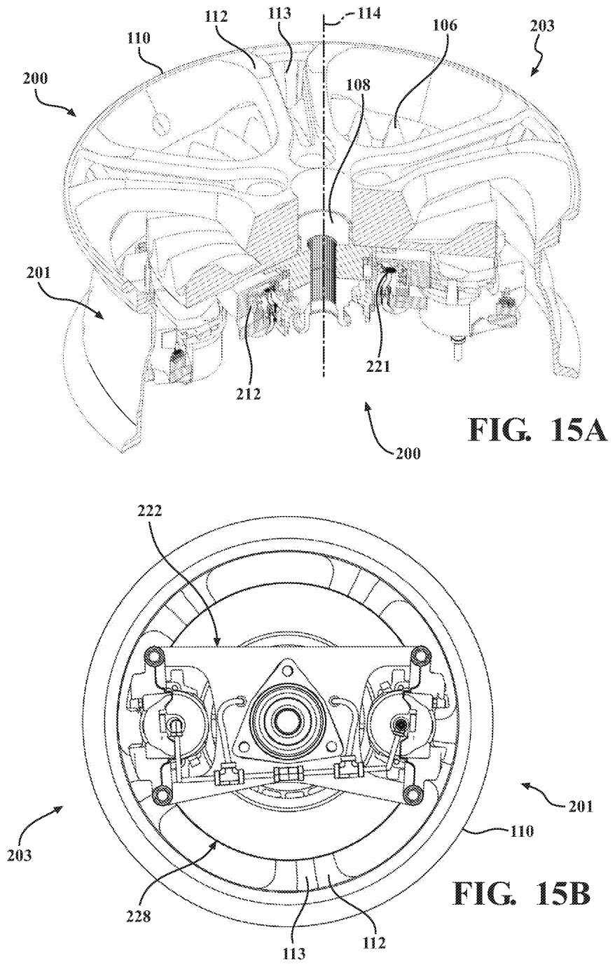

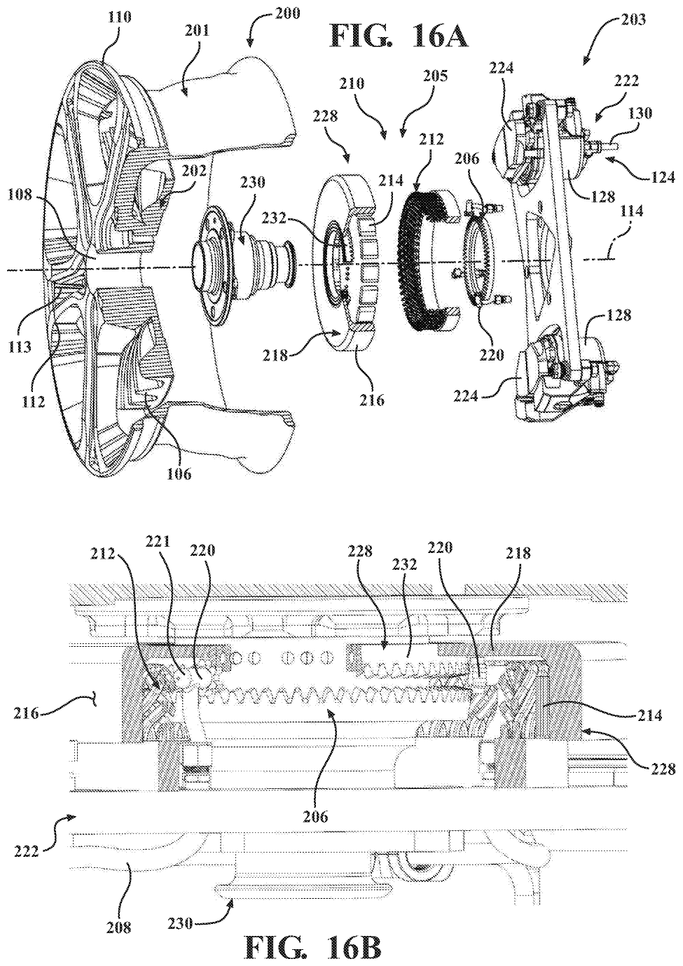

Referring now to FIGS. 15A, 15B, 16A, and 16B, an embodiment of a wheel and brake assembly 203 is shown. The wheel and brake assembly 203 includes a wheel assembly 200 and a braking assembly 205 for inhibiting rotation of a wheel 201 that is mechanically coupled to a wheel bearing 230. Thus, the wheel and brake assembly 203 may be referred to as a hybrid wheel and brake assembly as it utilizes both electric braking forces and mechanical braking forces. The wheel assembly 200 includes the wheel 201 and an integral brake rotor 202. The wheel assembly 200 and the wheel bearing 230 may rotate around the rotation axis 114. The braking assembly 205 includes a drive gear 206, an actuator 208, and an electric braking assembly 210 that includes a coil 212 surrounding the rotation axis 114 and a magnetic disc assembly 228 that is concentric with the coil 212 and is configured to rotate around the rotation axis 114 relative to the coil 212. The drive gear 206 may be coupled to the wheel bearing 230 such that the drive gear 206 rotates with the wheel bearing 230 (i.e., there is no relative rotation between the drive gear 206 and the wheel bearing 230). The magnetic disc assembly 228 includes a plurality of magnets 214 at a perimeter 216 of a disc 218 that includes a disc gear 232. The electric braking assembly 210 may also include one or more pinions 220 that may engage to mechanically couple the drive gear 206 and the disc 218 to cause relative rotation between the plurality of magnets 214 and the coil 212. The relative rotation generates an electro motive force that may inhibit rotation of the wheel 201 around the rotation axis 114. More specifically, the drive gear 206 rotates around the rotation axis 114 with the wheel 201 and the wheel bearing 230. Upon actuation of the electric braking assembly 210, a pinion 220 engages to couple the drive gear 206 with the disc gear 232, thus rotating the disc 218 with the wheel 201 and the wheel bearing 230 to generate an electro motive force that tends to inhibit rotation of the wheel 201 and induces a current. The current induced may be sent to a battery or other charge storing device via an electrical connection (not shown) of the charge storing device with the coil 212.

The braking assembly 205 further includes a mechanical braking assembly 222 that includes a brake pad 224, and a brake rotor 202 that is fixedly coupled to the wheel 201. In some embodiments, the brake rotor 202 is an integrated brake rotor, but it is to be understood that the brake rotor 202 may be separate from the other components of the wheel 201 in some embodiments. The mechanical braking assembly 222 may operate similarly and be constructed similarly to the mechanical braking assembly 120 and the mechanical braking assembly 120b, as described herein and in some embodiments may be substituted. Thus, the disclosure above with regard to the mechanical braking assembly 120 is equally applicable to the mechanical braking assembly 222 and, therefore, includes like reference numerals where appropriate. Similarly, it should also be appreciated that the brake rotor 202 may be substituted for either of the brake rotor 102, the brake rotor 102′, the brake rotor 102a, and the brake rotor 102b as like components discussed herein may be applicable between wheel assemblies.

The actuator 208 may actuate to couple the pinion 220 between the drive gear 206 and the disc gear 232. The pinion 220 may include a pinion gear piston 221 that is fluidly coupled with the actuator 208, such as a hydraulic actuator, in which hydraulic fluid may be applied to enter the pinion gear piston 221 from the actuator 208 forcing the pinion 220 into place. This may cause relative rotation between the coil 212, which does not rotate with respect to a body of a hypothetical vehicle to which the braking assembly 205 may be attached, and the disc 218. Additionally, the actuator 208 may actuate to cause the brake pad 224 to extend parallel to the rotation axis 114 to contact the brake rotor 202. For example, the brake pad 224 may be actuated by applying hydraulic fluid to fill the piston 128 and force the brake pad 224 into contact with the brake rotor 202, similarly to the mechanical braking assembly 120 as described herein.

In embodiments that include an integrated brake rotor and a single braking surface and brake pad, such as the integrated brake rotor 102 of FIGS. 3A and 3B, integration of the brake rotor 102 to a single side may reduce the size of components and provide an arrangement that allows for the integration of the coil 212 onto the wheel 101. That is, as shown in FIGS. 15A, 15B, 16A, and 16B, the coil 212 and the brake pad 224 may be integrated onto a single side of the wheel 201, affecting the wheel 201 from the same side.

In embodiments, the braking assembly 205, namely, the actuator 208, may actuate the electric braking assembly 210 and the mechanical braking assembly 222 based on different criteria. For example, the electric braking assembly 210 may be actuated to inhibit rotation of the wheel 201 around the rotation axis 114 based on a first engagement criteria (e.g., actuation at a particular rotational velocity of the wheel 201) and the mechanical braking assembly 222 may be actuated to inhibit rotation of the wheel 201 around the rotation axis 114 based on a second engagement criteria (e.g., actuation at a particular rotational velocity of the wheel 201). In embodiments, the first engagement criteria may be based on a first range of rotational velocities and the second engagement criteria may be based on a second range of rotational velocities that may or may not overlap the first range of rotational velocities. For example, a vehicle may include the electric braking assembly 210 and the mechanical braking assembly 222 and may travel at a particular speed. For example, the vehicle may travel at various speeds including, for example, 30 miles per hour (MPH), 45 MPH, and 70 MPH. In embodiments, the vehicle may actuate the electric braking assembly 210 to slow the vehicle when it is operating at high speeds (e.g., 70 MPH) and/or low speeds (e.g., 30 MPH) and may actuate the mechanical braking assembly 222 when it is operating at high speeds and/or at low speeds. In embodiments, the vehicle may engage the electric braking assembly 210 and/or the mechanical braking assembly 222 when it is travelling at medium speeds (e.g., 45 MPH). The particular rotational velocities of the wheel 201 and the speed of the vehicle and ranges thereof at which the electric braking assembly 210 and the mechanical braking assembly 222 may actuate are variable.

The electric braking assembly 210 may be electrically coupled to one or more systems to regenerate electrical energy to store, for example, in a battery bank of a vehicle to which the electric braking assembly 210 is attached. That is, relative rotational motion between the coil 212 and the plurality of magnets 214, which surrounds the coil 212, may induce a current in the coil 212 that can be used to charge a battery. In some embodiments, engagement of the electric braking assembly 210, and thus inducement of current, may be based on a vehicle speed. For example, the electric braking assembly 210 may be activated only when the vehicle is operating above, for example, 50 MPH, 60 MPH, 70 MPH, etc. The vehicle speed may be determined, as one example, based on a rotational velocity of the wheel 201. In embodiments, the mechanical braking assembly 222 may engage regardless of whether or not the electric braking assembly 210 is actuated. In some embodiments, engagement of one or both of the electric braking assembly 210 and the mechanical braking assembly 222 is based on a sensed magnitude of the braking force. For example, if a user of the vehicle pushes a brake pedal with a particular level of force (e.g., a relatively high level of force), both the electric braking assembly 210 and the mechanical braking assembly 222 may engage. In embodiments, if the user pushes a brake pedal with a relatively low level of force, only one of the electric braking assembly 210 and the mechanical braking assembly 222 may engage. In such embodiments, which of the two assemblies engages may be based on a vehicle speed (as determined, for example, based on a rotational velocity of the wheel).

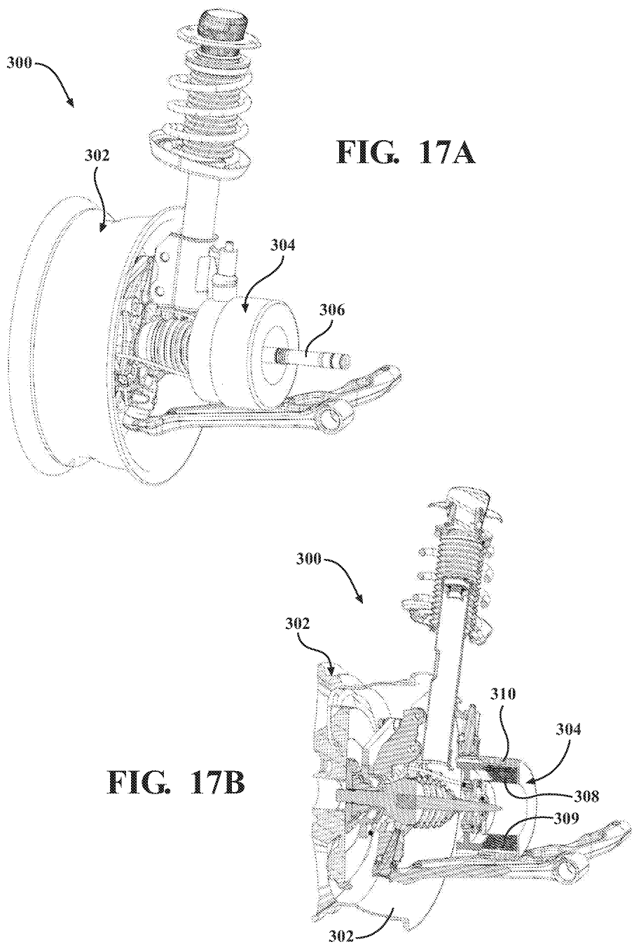

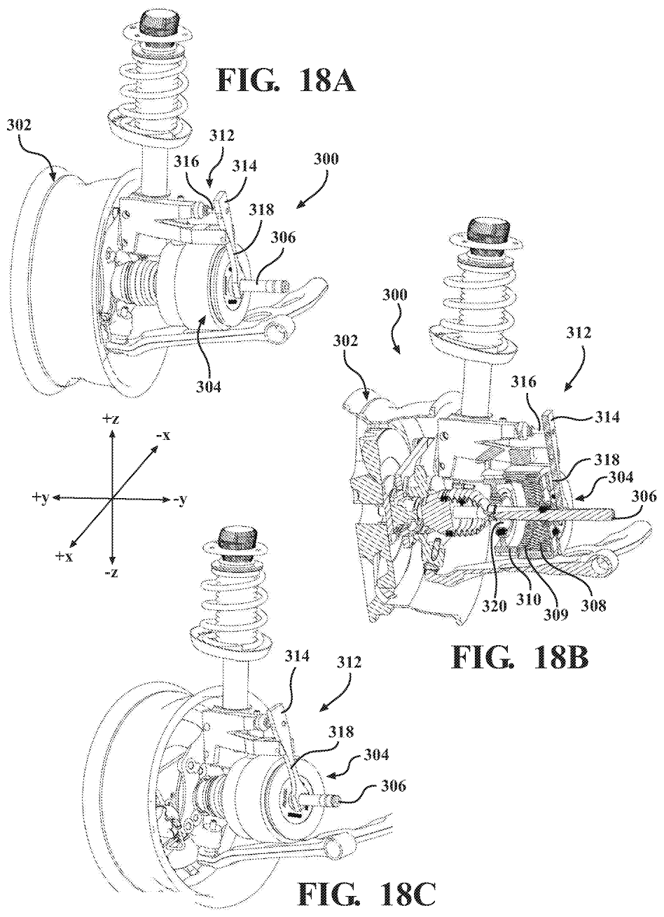

Referring now to FIGS. 17A, 17B, 18A, 18B, and 18C, a motor/generator assembly 300 for causing rotation of a wheel assembly or wheel 302, such as the wheel assembly 100, the wheel assembly 100a, and the wheel assembly 100b, and inhibiting rotation of a wheel 302 around an axle 306 using a motor/generator 304 is schematically depicted. The motor/generator 304 includes a rotor coil 308 and a stator 310. The stator 310 includes one or more magnets 309 and is configured concentrically with the rotor coil 308 such that rotation of the rotor coil 308 with respect to the stator 310 induces an electric current and generates an electro motive force. The stator 310 and the rotor coil 308 may each be mounted to the axle 306 or some other portion of the motor/generator assembly 300 such that they are able to rotate with respect to one another. For example, the rotor coil 308 and the stator 310 may be mounted on a rotating bearing 320. The rotor coil 308 may be coupled with the axle 306 such that the rotor coil 308 rotates with the axle 306 while the stator 310 is mounted to the axle 306 via the rotating bearing 320 such that the stator 310 is able to rotate with respect to the rotor coil 308 and the axle 306. FIGS. 17A, 17B, 18A, 18B, and 18C also include various devices and assemblies for connecting the wheel 302 to a hypothetical vehicle (e.g., a strut and shock assembly, a steering system connection, a vehicle knuckle, and the like).

Referring to FIGS. 18A, 18B, and 18C, the motor/generator assembly 300 includes an actuation assembly 312. The actuation assembly 312 includes an actuation arm 314 that is configured to move inward and outward (i.e., in the +/−y direction of the coordinate axis) based on actuation of a piston 316 of the actuation assembly 312. The piston 316 may move the actuation arm 314 such that a contact portion 318 of the actuation arm 314 contacts the stator 310 to stop the stator 310 from rotating such that relative motion is created between the rotor coil 308 and the stator 310. The actuation arm 314 may include a saddle connection to the axle 306 that allows the axle 306 to rotate with respect to the actuation arm 314, but it is contemplated that any connection between the actuation arm 314 and the axle 306 that allows for relative rotational therebetween may be used. In some embodiments, there is no connection between the actuation arm 314 and the axle 306.

In operation, the actuation assembly 312 actuates the piston 316 to push or pull the actuation arm 314 outward or inward, respectively. As the piston 316 moves, the actuation arm 314 makes contact with the stator 310 and prevents it from rotating with respect to the rotor coil 308. That is, the rotor coil 308 is directly coupled with the axle 306, and thus rotates with the axle 306. As the actuation arm 314 engages, rotation of the stator 310 is inhibited and an electromotive force is generated and a current is induced by the relative motion between the rotor coil 308 and the stator 310. This electromotive force tends to inhibit rotation of the axle 306 and the wheel 302. The induced current can be stored in a battery or other charge store as described herein.

Conversely, the motor/generator assembly 300 can act as a motor, generating an electromotive force that turns the wheel 302. That is, the actuation arm 314 may be engaged with the stator 310 to inhibit its rotation and an electric current may be applied to the rotor coil 308 creating an electromotive force that tends to cause the rotor coil 308, and thus the wheel 302 to rotate. Such an electromotive force may cause a hypothetical vehicle to which the wheel 302 may be attached to be propelled forward or backward depending on the direction the current is applied to the rotor coil 308.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It should be understood that the figures described herein are not necessarily to scale. However, it is to be understood that the disclosed aspects are merely illustrative and may be embodied in various and alternative forms. Therefore, specific details disclosed herein are not to be interpreted as limiting, but merely as a representative basis for any aspect of the methods, systems, and devices described herein and/or as a representative basis for teaching one skilled in the art to variously employ the methods, systems, and devices described herein.

It is also to be understood that the methods, systems, and devices described herein are not limited to the specific aspects and methods described herein, as specific components and/or conditions may, of course, vary. Furthermore, the terminology used herein is used only for the purpose of describing particular aspects and is not intended to be limiting in any way.

It will be understood that, although the terms “first,” “second,” “third,” etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Various modifications of the present invention, in addition to those shown and described herein, will be apparent to those skilled in the art of the above description. Such modifications are also intended to fall within the scope of the appended claims.

It is appreciated that all reagents are obtainable by sources known in the art unless otherwise specified.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular embodiments of the invention, but is not meant to be a limitation upon the practice thereof.

1. A braking assembly for inhibiting rotation of a wheel around a rotation axis, the braking assembly comprising:
a drive gear configured to rotate with the wheel, the drive gear including a pinion;
an actuator;
an electric braking assembly comprising:
a coil surrounding the rotation axis; and
a magnetic disc assembly concentric with the coil and configured to rotate relative to the coil, the magnetic disc assembly comprising a plurality of magnets at a perimeter of a disc;
a mechanical braking assembly comprising a brake pad; and
a brake rotor that is fixedly coupled to the wheel,
wherein the actuator engages the pinion to mechanically couple the drive gear and the magnetic disc assembly to cause relative rotation between the plurality of magnets and the coil to generate an electro motive force that inhibits rotation of the wheel around the rotation axis,
wherein the actuator engages the brake pad such that the brake pad contacts the brake rotor causing friction that inhibits relative rotation between the wheel and the brake pad.

2. The braking assembly of claim 1, wherein the brake rotor is an alloy brake rotor.

3. The braking assembly of claim 1, wherein the brake rotor is an aluminum brake rotor.

4. (canceled)

5. The braking assembly of claim 1, wherein the brake rotor and the wheel are integrated.

6. The braking assembly of claim 1, wherein;
the actuator engages the electric braking assembly based on a first engagement criteria; and
the actuator engages the mechanical braking assembly based on a second engagement criteria different than the first engagement criteria.

7. (canceled)

8. The braking assembly of claim wherein:
the first engagement criteria is based on a first rotational velocity range; and
the second engagement criteria is based on a second rotational velocity range different than the first rotational velocity range.

9. The braking assembly of claim 8, wherein the first rotational velocity range and the second rotational velocity range overlap.

10-12. (canceled)

13. The braking assembly of claim 1, wherein the plurality of magnets surrounds the coil.

14. The braking assembly of claim 1, wherein:
the brake rotor comprises a contoured profile; and
the brake pad comprises a contoured profile that matches the contoured profile of the brake rotor.

15. The braking assembly of claim 14, wherein the contoured profile of the brake rotor comprises a curve.

16. A wheel assembly comprising:
a wheel comprising:
a hub;
a rim; and
one or more spokes extending between the hub and the rim;
a brake rotor integrated with the wheel, said brake rotor comprising:
a braking surface;
a plurality of fins; and
an alloy.

17. The wheel assembly of claim 16, wherein the wheel and the brake rotor comprise the same material.

18. The wheel assembly of claim 16, wherein the wheel and the integrated brake rotor comprise aluminum.

19. The wheel assembly of claim 16, wherein the braking surface includes a liner.

20. The wheel assembly of claim 19, wherein the liner is a FeN layer.

21. The wheel assembly of claim 19, wherein the integrated brake rotor further comprises a second braking surface that is opposite the braking surface.

22. The wheel assembly of claim 21, wherein the second braking surface includes a second liner.

23. The wheel assembly of claim 22, wherein the second liner is a FeN layer.

24. (canceled)

25. The wheel assembly of claim 16, wherein:
the braking surface comprises a contoured profile; and
a brake pad comprises a contoured profile that matches the contoured profile of the braking surface.

26. The wheel assembly of claim 25, wherein the contoured profile of the braking surface comprises a curve.

27-36. (canceled)

37. A motor/generator assembly for rotating and inhibiting rotation of a wheel on a vehicle, the motor/generator assembly including:
a rotating bearing;
a rotor coil mounted to an axle such that it rotates with the axle as the wheel rotates;
a stator including one or more magnets, the stator coupled to the rotor coil via the rotating bearing and concentric with the rotor coil about the axle; and
an actuation assembly including an actuation arm, the actuation assembly configured to actuate the actuation arm to contact the stator,
wherein contact of the actuation arm with the stator inhibits rotation of the stator with respect to the vehicle, thereby causing relative rotation between the rotor coil and the stator.

38. The motor/generator assembly of claim 37, further comprising the wheel assembly of claim 16.

39-40. (canceled)
